(19) United States
(12) Patent Application Publication
(10) Pub. No.: US 2025/0322239 A1
(43) Pub. Date: Oct. 16, 2025

(54) RAPID DEPLOYMENT OF DEEP NEURAL NETWORKS (DNNS) FOR EDGE COMPUTING VIA STRUCTURED PRUNING AT INITIALIZATION

(71) Applicant: Rakuten Mobile, Inc., Tokyo (JP)

(72) Inventors: Bailey ECCLES, St Andrews (GB); Blesson VARGHESE, St Andrews (GB); Jee Chang, Leon WONG, Tokyo (JP)

(21) Appl. No.: 18/635,038

(22) Filed: Apr. 15, 2024

(51) Int. Cl. G06N 3/082

(52) U.S. Cl. CPC G06N 3/082

(57) ABSTRACT

A method, system, and transitory computer-readable media for providing rapid deployment of Deep Neural Networks (DNNs) for Edge Computing using Structured Pruning at Initialization (SPaI). An input of a dense model and a pruning amount is received. Unstructured Pruning (UP) of the input model is performed by the pruning amount to generate a sparse model pruned by the pruning amount. The sensitivity of each layer of the sparse model to pruning is evaluated by contrasting a sparsity of the sparse model with an average sparsity of a global model to generate a structured pruning plan. The structured pruning plan is applied to the resilient layers. A remaining sensitive layers are reinitialized to produce an initialized model pruned by the pruning amount. The initialized model pruned by the pruning amount is provided as an output.

### FIELD

The present disclosure relates to rapid deployment of Deep Neural Networks (DNNs) for edge computing via structured pruning at initialization.

### BACKGROUND

Edge machine learning (ML) enables localized processing of data on devices and is underpinned by Deep Neural Networks (DNNs). Deep neural networks (DNNs) are used in many applications to process and analyze data at the network edge, eliminating the need to send data to the cloud. Examples of applications include security cameras for facial recognition, wearable health monitors, and the like. These DNN models are often over-parameterized for the application task, requiring a large amount of computing resources for training and deployment. Thus, DNNs cannot be easily run on devices due to their substantial computing, memory and energy usage for delivering performance that is comparable to cloud-based ML. Therefore, model compression techniques, such as pruning, have been considered. Existing pruning methods are problematic for edge computers because the existing pruning method (1) create compressed models that have limited runtime performance benefits (using unstructured pruning) or compromise the final model accuracy (using structured pruning), and (2) use substantial compute resources and time for identifying a suitable compressed DNN model, e.g., using neural architecture search.

Edge devices such as mobile phones and embedded devices cannot support large cloud-centric DNN models due to computational, memory, and energy constraints. These constraints are accounted for by methods such as model compression that reduce the resource used for model training and inference while preserving task accuracy. Model compression methods include model knowledge distillation, quantization, Neural Architecture Search (NAS), pruning, and the like.

Model pruning removes specific parameters from over-parameterized dense DNNs while offering fine-grained tailoring of models for specialized tasks. In contrast to other model compression methods, model pruning is beneficial in edge computing environments, where optimizing models is used for diverse applications with heterogeneous computational constraints and capabilities. For example, edge-oriented model training paradigms, such as federated learning, make use of model pruning to expedite the training time of straggler devices. Model pruning is categorized as Unstructured Pruning (UP) and Structured Pruning (SP). UP sets parameter weights to zero, while SP removes groups of parameters. UP retains model accuracy, whereas SP enhances compression and training speed. Compared to pruning, Neural Architecture Search (NAS) finds a range of models from a vast search space but takes longer due to search and training time.

Typically pruning occurs after or during model training. However, Pruning at Initialization (PaI), e.g., before training, enables discovery of a subnetwork of randomly initialized parameters that, when fully trained, is able to match the accuracy of the original dense network. However, Unstructured PaI (UPaI) and Structured PaI (SPaI) have different goals. UPaI maintains model accuracy without improving runtime performance. SPaI improves performance but reduces accuracy. Accordingly, a need exists for a system that facilitates rapid pruning of DNN models for edge development that provides accuracy and improves runtime performance.

### SUMMARY

In at least embodiment, a method for providing rapid deployment of Deep Neural Networks (DNNs) for Edge Computing using Structured Pruning at Initialization (SPaI) includes receiving as an input a dense model and a pruning amount. Unstructured Pruning (UP) of the input model is performed by the pruning amount to generate a sparse model pruned by the pruning amount. The sensitivity of each layer of the sparse model to pruning is evaluated by contrasting a sparsity of the sparse model with an average sparsity of a global model to generate a structured pruning plan. The structured pruning plan is applied to the resilient layers. A remaining sensitive layers are reinitialized to produce an initialized model pruned by the pruning amount. The initialized model pruned by the pruning amount is provided as an output.

In at least one embodiment, a system for rapid deployment of Deep Neural Networks (DNNs) for edge computing via structured pruning at initialization, wherein the system is configured for receiving as an input a dense model and a pruning amount. Unstructured Pruning (UP) of the input model is performed by the pruning amount to generate a sparse model pruned by the pruning amount. The sensitivity of each layer of the sparse model to pruning is evaluated by contrasting a sparsity of the sparse model with an average sparsity of a global model to generate a structured pruning plan. The structured pruning plan is applied to the resilient layers. A remaining sensitive layers are reinitialized to produce an initialized model pruned by the pruning amount. The initialized model pruned by the pruning amount is provided as an output.

In at least one embodiment, a non-transitory computer-readable media having computer-readable instructions stored thereon, which when executed by a processor causes the processor to perform operations including receiving as an input a dense model and a pruning amount. Unstructured Pruning (UP) of the input model is performed by the pruning amount to generate a sparse model pruned by the pruning amount. The sensitivity of each layer of the sparse model to pruning is evaluated by contrasting a sparsity of the sparse model with an average sparsity of a global model to generate a structured pruning plan. The structured pruning plan is applied to the resilient layers. A remaining sensitive layers are reinitialized to produce an initialized model pruned by the pruning amount. The initialized model pruned by the pruning amount is provided as an output.

### BRIEF DESCRIPTION OF THE DRAWINGS

Features, aspects, and advantages of certain exemplary embodiments of the disclosure will be described below with reference to the accompanying drawings, in which like reference numerals denote like elements, and wherein:

FIG. 1 shows runtime differences between compression methods.

FIG. 2 illustrates four stages of different pruning at initialization (PaI) methods applied to a convolutional layer.

FIGS. 3A-B illustrate a comparison of the accuracy and normalized training time for a Dense DNN model, UPaI, and SPaI.

FIG. 4 illustrates a UPaI/SPaI Combination Pruning System according to at least one embodiment.

FIGS. 5A-B illustrates the convolution layer index Pre-PSE and Post-RLR according to at least one embodiment.

FIGS. 6A-C, 7A-C, 8A-C, and 9A-C are comparisons of test accuracy, compression, and CPU/GPU speedup across a range of sparsities for a selection of UPaI and SPaI pruning methods according to at least one embodiment.

FIGS. 10A-B shows the results for VGG-16 and ResNet-20 according to at least one embodiment.

FIG. 11 is a flowchart of a method for providing rapid deployment of Deep Neural Networks (DNNs) for Edge Computing using Structured Pruning at Initialization (SPaI) according to at least one embodiment.

FIG. 12 illustrates an exemplary embodiment of a device according to at least one embodiment.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched, as long as these modifications may not affect the resulting scope of the invention.

It will be apparent that systems and/or methods described herein, may be implemented in different forms of hardware, software, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of implementations. In fact, many of these features may be combined in ways not specifically recited in the claims and/or disclosed in the specification. Although each dependent claim listed below may directly depend on only one claim, the embodiments described herein include each dependent claim in combination with every other claim in the claim set.

No element, act, or instruction used herein are to be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of A and B”, “A and/or B”, or “at least one of A or B” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from practice of the implementations.

In at least one embodiment, a method for providing rapid deployment of Deep Neural Networks (DNNs) for Edge Computing using Structured Pruning at Initialization (SPaI) includes receiving as an input a dense model and a pruning amount. Unstructured Pruning (UP) of the input model is performed by the pruning amount to generate a sparse model pruned by the pruning amount. The sensitivity of each layer of the sparse model to pruning is evaluated by contrasting a sparsity of the sparse model with an average sparsity of a global model to generate a structured pruning plan. The structured pruning plan is applied to the resilient layers. A remaining sensitive layers are reinitialized to produce an initialized model pruned by the pruning amount. The initialized model pruned by the pruning amount is provided as an output.

Embodiments described herein provide method that provides one or more advantages. For example, pruned models suited for edge deployments are rapidly generated using structured Pruning at Initialization (PaI) by systematically identifying convolutional layers of a Deep Neural Network (DNN) that are most sensitive to Structured Pruning and prunes only the non-sensitive layers. At least one embodiment rapidly prunes DNNs within seconds and are much smaller and faster (e.g., up to 16.21× smaller and 2×faster) while the same accuracy as an unstructured PaI counterpart is maintained.

Deep neural networks (DNNs) are used in many applications to process and analyze data at the network edge, eliminating the need to send data to the cloud. Examples of applications include security cameras for facial recognition, wearable health monitors, and the like. These DNN models are often over-parameterized for the application task, requiring a large amount of computing resources for training and deployment.

Edge devices such as mobile phones and embedded devices cannot support large cloud-centric DNN models due to computational, memory, and energy constraints. These constraints are accounted for by methods such as model compression that reduce the resource used for model training and inference while preserving task accuracy. Model compression methods include model knowledge distillation, quantization, Neural Architecture Search (NAS), pruning, and the like.

Model compression methods such as pruning and NAS introduce many benefits for edge computing. However, there is a three-fold challenge that impacts the deployment of compressed models in the edge setting: (1) Retaining the accuracy of the compressed model similar to that of the original dense model, (2) Achieving model compression that empirically decreases training and inference latency and model size, and (3) Discovering a pruned model rapidly and efficiently. While existing methods can address up to two of these challenges simultaneously, they do not address three at the same time.

Model pruning removes specific parameters from over-parameterized dense DNNs while offering fine-grained tailoring of models for specialized tasks. In contrast to other model compression methods, model pruning is beneficial in edge computing environments, where optimizing models is used for diverse applications with heterogeneous computational constraints and capabilities. For example, edge-oriented model training paradigms, such as federated learning, make use of model pruning to expedite the training time of straggler devices. Model pruning is categorized as Unstructured Pruning (UP) and Structured Pruning (SP). UP sets parameter weights to zero, while SP removes groups of parameters. UP retains model accuracy, whereas SP enhances compression and training speed. Compared to pruning, Neural Architecture Search (NAS) finds a range of models from a vast search space but takes longer due to search and training time. NAS explores how many different layers are to be used, how wide each layer is to be, or what different types of layers are to be added. NAS still finds architectures with the architecture search, but the search and train process is run so many times that a lot of redundant or other architectures are found that are worse.

The goal of DNN pruning is to reduce the computational complexity of models by removing redundant parameters known as weights or connections. An ideal pruning method will prioritize the removal of parameters that contribute the least to model accuracy for maintaining usability after compression. Pruning methods are categorized as Unstructured Pruning (UP) and Structured pruning (SP).

### Unstructured Pruning (UP)

Unstructured Pruning (UP) prunes a neural network at a granular level by zeroing or setting weights to 0. The DNN is trained on a data set and UP adjusts and changes the weights over time. Some weights will converge to certain values and then at the end of training the weights are analyzed. The weights are ranked in order of size. UP masks individual parameters by setting the their value to zero. UP sets a set of smaller weights to 0. However, there are other methods that look at different metrics to decide which weights to turn off. Network parameters set to zero are ignored. A ranking algorithm determines which parameters to mask using simple metrics such as the magnitude of the weights, to more complex criteria utilizing activation or gradient information during training. By masking parameters, the model becomes sparse, referred to as a sparse model, and the original model is referred to as a dense model. In terms of computer systems, a wight set to zero turns off that parameter so that it is not used. However, the parameter still exists and thus still takes up memory because it still exists within other data structures that are being used. Some processors still process these weights, or still store the values. While UP maintains model accuracy between ˜50-90% depending on the model, dataset, and pruning method, sparse models only provide runtime performance improvements in cloud scenarios or where specific inference libraries for sparse matrix formats are available on the edge.

Edge devices might not be equipped with hardware accelerators, such as Graphics Processing Units (GPUs), or may not support sparse matrix representations and libraries. Consequently, sparse models on the edge have limitations. Firstly, scattered sparsity in dense convolutions leads to irregular memory access patterns, which hinder model training and inference. Secondly, since zeroed parameters still consume the same memory as non-zero parameters, there is no gain in memory efficiency.

### Structured Pruning (SP)

With Structured Pruning (SP), neural networks are initialized with random values or pseudo random values, and, after training, groups of parameters, such as filters, channels, or layers, are removed. Thus, the DNN no longer performs the removed processes or spends energy running the removed portions of the DNN. SP results in a spatially smaller pruned model, which is beneficial to edge scenarios with a high demand for models with low memory, energy, and inference footprints. However, obtaining high-quality pruned models is challenging since (1) SP is oriented towards runtime performance improvements. Therefore, profiling every prospective model from a large search space can take hours to days to find a single high-quality pruned model. (2) At higher sparsities, essential parameters are inevitably removed; fine-tuning is used to regain accuracy, which can take many times longer than the original model training time for complex datasets; instead, training a new model of the same size from scratch may result in better accuracies.

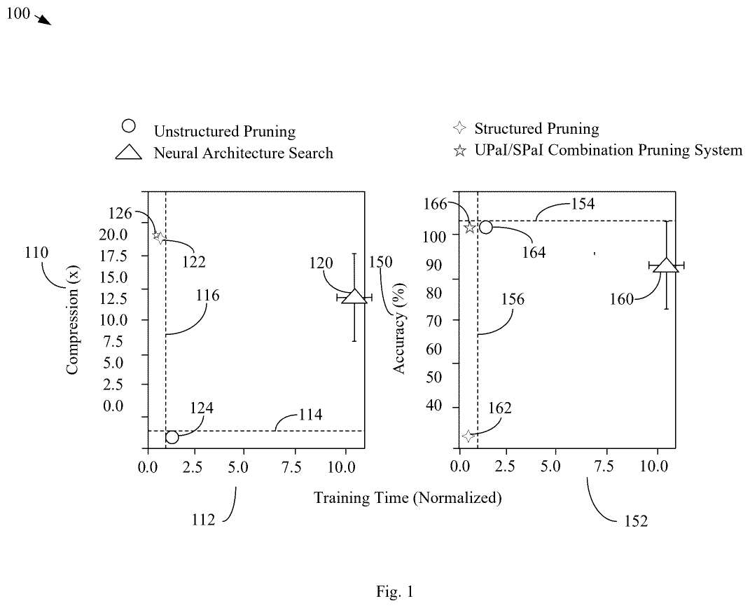

FIG. 1 shows runtime differences between compression methods 100.

In FIG. 1, a plot of compression 110 versus normalized training time 112 is shown on the left. A plot of accuracy 150 versus normalized training time 152 is shown on the right. Model compression methods are evaluated to reduce parameter count of Visual Geometry Group-16 (VGG-16) (CIFAR-10) by 50×. VGG-16 is a deep Convolutional Neural Network (CNN) architecture with 16 layers. Canadian Institute For Advanced Research-10 (CIFAR-10) is a dataset that contains 60,000 32×32 color images in 10 different classes. Horizontal dashed lines 114, 154 and vertical dashed lines 116, 156 represent the baseline values of an uncompressed dense VGG-16. The bars for Neural Architecture Search (NAS) 120, 160 include the discovery time for generating a range of compressed models with different levels of compression and accuracy.

For compression 110, SP 122 provides approximately 16.25× Compression 110 with a Training Time 112 of approximately 0.7 relative units. UP 124 provides approximately 1.25× Compression 110 with a Training Time 112 of approximately 1.25 relative units. NAS 120 provides approximately 12.0× Compression 110 with a Training Time 112 of approximately 10.0 relative units. UPaI/SPaI Combination Pruning System 126 provides Compression 110 of approximately 16.25% and a Training Time 112 of approximately 0.7 relative units.

In terms of Accuracy, SP 162 provides an Accuracy of approximately 45% and a Training Time 152 of approximately 0.7 relative units, whereas UP 164 provides an Accuracy 164 of approximately 92% and a Training Time 152 of approximately 1.5 relative units. NAS 160 provides an accuracy of approximately 85% and a Training Time 152 of approximately 10 relative units. UPaI/SPaI Combination Pruning System 166 provides Compression 150 of approximately 95% and a Training Time 152 of approximately 0.7 relative units.

Table I shows a comparison of unstructured pruning (UP), structured pruning (SP), neural architecture search (NAS).

TABLE I

| Comparison Of | | | | UPaI/SPaI Combination |
|---|---|---|---|---|
| Unstructured Pruning | UP | SP | NAS | Pruning System |
| Maintain High | ✓ | X | ✓ | ✓ |
| Accuracy | | | | |
| Smaller and Faster | X | ✓ | ✓ | ✓ |
| Rapidly Discovered | ✓ | ✓ | X | ✓ |

In Table I, models generated by UP have high accuracy and are easily discoverable. However, UP does not achieve model compression that empirically decreases training and inference latency and model size. Models generated by SP are smaller and faster, and easily discoverable but often have low accuracies, and therefore, lack usability for accuracy-critical edge applications. NAS have high accuracy and are smaller and faster, but are not easily discoverable. As discussed in detail below, UPaI/SPaI Combination Pruning System according to at least one embodiment addresses these three challenges by maintaining high accuracy, smaller and faster models, and rapid discovery.

### Pruning at Initialization (PaI)

As mentioned, pruning typically occurs after or during model training. However, Pruning at Initialization (PaI), e.g., before training, enables discovery of a subnetwork of randomly initialized parameters that, when fully trained, is able to match the accuracy of the original dense network. However, Unstructured PaI (UPaI) and Structured PaI (SPaI) have different goals. UPaI maintains model accuracy without improving runtime performance. SPaI improves performance but reduces accuracy.

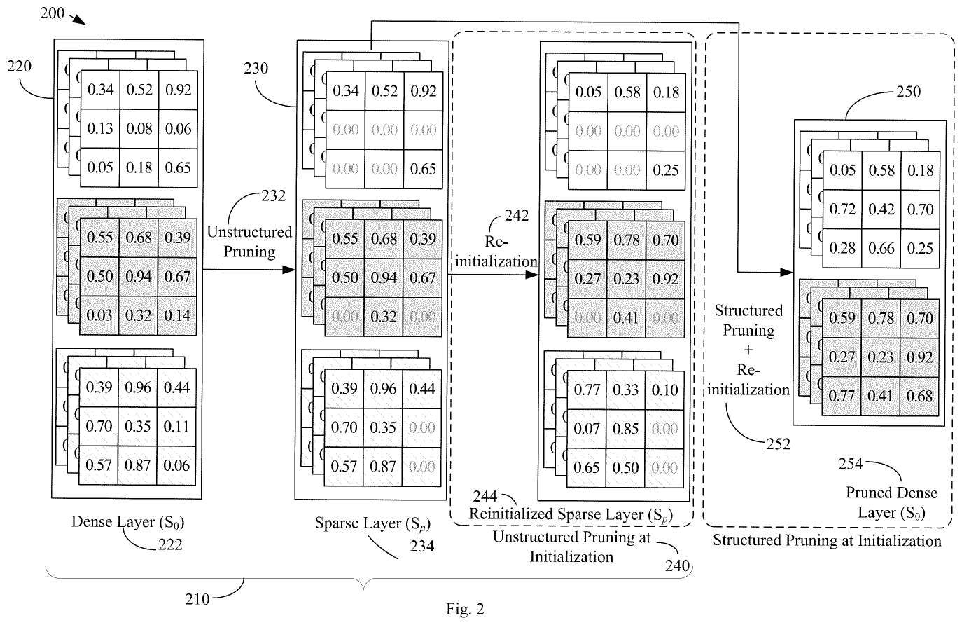

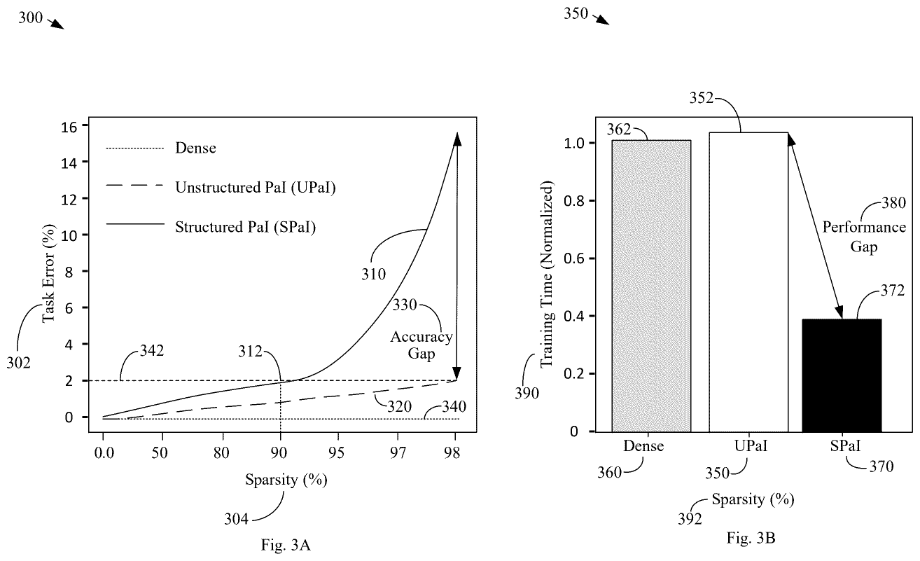

FIG. 2 illustrates four stages of different pruning at initialization (PaI) methods applied to a convolutional layer 200.

In FIG. 2, Unstructured PaI 232 and Structured PaI 250 are applied to a convolutional layer.

### Unstructured Pruning at Initialization

Unstructured PaI (UPaI) involves UP 230 of a dense network, then Reinitializing 242 the remaining parameters before training. UPaI can match the accuracy within 1% of a dense model up to ˜98% sparsity. The first three stages 210 in FIG. 2 visualize the generalized approach of UPaI. The first stage 220 shows the Dense Layer (S₀) 222. Then, at the second stage 230, Unstructured PaI (UPaI) 232 is applied to produce Sparse Layer (Sp) 234. Next, at the third stage 240, the remaining parameters of the Sparse Layer (Sp) 234 are Reinitialized 242 to produce Reinitialized Sparse Layer (Sp) 244. While UPaI 240 presents the opportunity to accelerate training by using the Sparse Model (Sp) 234 as a drop-in replacement to the original Dense Model 222, UPaI 240 encounters challenges in edge scenarios for the same reasons as UP.

### Structured Pruning at Initialization

For improved runtime performance, Structured PaI (SPaI) 250 extends UPaI 240. While UPaI 240 produces a Sparse Model (Sp) 244, SPaI 250 introduces an additional step before reinitialization: the Sparse Layer (Sp) model 234 is pruned using SP 252. The fourth stage 250 takes the Sparse Layer (Sp) 234 and applies Structured Pruning with Reinitialization 252 to produce a Pruned Dense Layer (S₀) 254. Pruned Dense Layer (S₀) 254 has the parameters redistributed such that a smaller layer of only dense kernels is created. Thus, SPaI 250 spatially compresses the model, and then, sparse layers are converted into dense layers of the same parameter count, which improves hardware utilization.

For example, a 33% 3-channel sparse layer is converted into a dense 2-channel layer with the same parameter count. SPaI 250 presents an opportunity for edge-compatible pruned models to be discovered within seconds, significantly outperforming neural architecture methods (NAS) in search time. In addition, SPaI 250 has lower overheads than NAS, allowing for execution on the edge where on-device metrics can be gathered to create tailored pruned models for each device.

### Structured PaI Challenges

Implementing SPaI 250 in the manner described in FIG. 2 raises the following questions: Do dense layers from SPaI 250 achieve the same accuracy as sparse layers from UPaI 240 when both have the same number of parameters? In previous methods, an individual parameter that is located within a layer holds no significance for UPaI 240; the layer-wise sparsity ratio is more critical to model accuracy. Therefore, SPaI 250, in theory, achieves close to, or the same, accuracy as UPaI 240.

The goal to is to be more favorable towards edge devices, such as mobile phones, cameras, and the like, which do not have as much computational power as the computational power available in the cloud. To be able to use on edge devices, the model is to be an order of magnitude smaller. For example, a mobile phone includes a smaller memory, e.g., 1 GB. According to at least one embodiment, a machine learning model deployed in a mobile phone is to meet that memory constraints.

FIGS. 3A-B illustrate a comparison of the accuracy and normalized training time for pruning methods 300.

In FIG. 3A, SPaI 312 is shown maintaining accuracy close to UPaI 320 up to ˜90% 312 before quickly collapsing. UPaI 320 provides more model accuracy. This property holds true for most model architectures and datasets. Sparsity (%) 304 looks at the percentage of the weights that are set to 0. In a 90% sparse model only one in 10 weights are not set to 0. Task Error 302 quantifies the relative accuracy difference between a pruned model and the baseline (dense) model 340. As shown in FIG. 3A, in UPaI 320, the Task Error 302 is approximately 98%, i.e., 2% accuracy 342 is lost. However, with SPaI 310, the Task Error 302 begins to increase exponentially after a certain point, e.g., past 90% sparsity 312, thereby resulting in Accuracy Gap 330.

FIG. 3B shows that UPaI 350 does not improve runtime performance in comparison to the Dense DNN model 360, while SPaI 370 improves the performance. FIG. 3B shows Training Time 390 verses Sparsity (%) 392. With UPaI 350, the Training Time 352 is comparable to the Training Time 362 of the Dense Model 360 but is greater than the Training Time 372 of SPaI 370. A Performance Gap 380 thus exists between SPaI 370 and UPaI 350. UPaI 350 is slower than SPaI 370 because the amount of zeros introduced into the neural network is causing performance issues where certain schedulers and memory allocators are trying to move around these zeros. Thus, as shown in FIG. 3A SPaI 310 experiences higher errors than UPaI 320 but as shown in FIG. 3B the models from SPaI 370 are much faster than the models from UPAI 350.

Existing model pruning systems comprise only one of the two types of pruning at initialization. In cloud-oriented systems, there is a greater emphasis on model accuracy due to the availability of abundant computational resources. However, the efficiency of model discovery and model latency is still considered, especially considering costs and operational constraints. On the other hand, when it comes to edge computing, model pruning methods aim to balance model accuracy with the stringent resource constraints of devices. While accuracy is reduced, the goal is typically to achieve significant model compression without compromising performance. Structured pruning at initialization (SPaI) 370 aims to achieve a balance similar to post-training hybrid pruning methods. However, pruning at initialization of the model (before training) offers the added advantage of increased training efficiency. As a result, SPaI 370 enables models to be trained on edge devices that have limited computational and memory resources. Alternatively, in cloud environments, SPaI 370 is able to reduce operational expenses.

Existing SPaI 370 that aims to address the Accuracy Gap 330 and Performance Gap 380 in FIGS. 3A-B have the following limitations that significantly reduce model accuracy. First, existing SPaI methods fully re-parameterize sparse models into pruned models, thereby removing the fine-grained accuracy-preserving properties of unstructured pruning. Second, existing SPaI methods apply the same pruning method to the layers of the model. This inherently prunes important layers while under pruning redundant layers. These limitations have led to SPaI systems with worse model accuracy than simply training a new, smaller model from scratch.

Other Compression Methods, such as quantization, reduce the bit precision of DNN parameters to shrink the model and increase inference speed. However, quantization often leads to accuracy loss and often involves specialized hardware for lower-precision inference. Knowledge distillation refers to the process of transferring knowledge from a large model to a smaller one.

Although the smaller model often matches the accuracy of the larger model and takes up less space, the smaller model is not easily adaptable to different model architectures. Consequently, the smaller model is not scalable for the diverse needs of heterogeneous edge settings.

Pruning systems are employed to compress DNN models, creating a range of compact models ideally suited for edge devices. These pruned models optimize resource constraints while maintaining performance on edge deployments. Prior pruning systems primarily focus on pruning after model training, or target model architectures for hardware accelerators.

Neural Architecture Search (NAS) automates the process of finding optimal DNN model architectures. Traditionally NAS is used to discover larger models that train to higher accuracies. However, NAS has also been employed to discover smaller models optimized for edge devices. While NAS is effective at discovering high-quality models, redoing the task for a new dataset is time-consuming and resource-intensive.

Model Reparameterization aims to optimize model structures, enhancing hardware utilization and thereby improving inference efficiency. For example, Re-parameterized Visual Geometry Group (RepVGG) re-parameterizes Residual Network (ResNet) architectures into VGG-style models. ResNet is a deep learning model in which the weight layers learn residual functions with reference to the layer inputs. However, these methods only work on specific pairs of model architectures and use hardware accelerators to maximize utilization, such as Graphics Processing Units (GPUs), which may not always be available on edge devices.

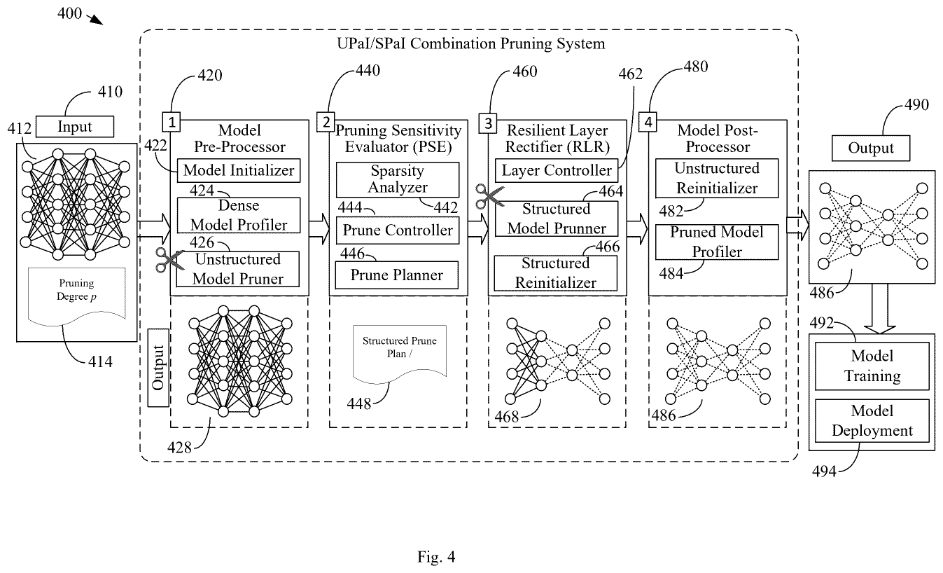

FIG. 4 illustrates a UPaI/SPaI Combination Pruning System 400 according to at least one embodiment.

In FIG. 4, the UPaI/SPaI Combination Pruning System 400 according to at least one embodiment addresses the above limitations by adding a two-step process to SPaI that determines how sensitive each layer is to structured pruning in order to provide rapid deployment of DNNs for edge computing. The UPaI/SPaI Combination Pruning System 400 according to at least one embodiment provides control for the amount and type of pruning of each layer in order to maximize model compression and speeds up the process while minimizing accuracy loss.

The UPaI/SPaI Combination Pruning System 400 according to at least one embodiment includes four modules 420, 440, 460, 480 as part of the SPaI pipeline. The four modules include Model Pre-Processor 420, Pruning Sensitivity Evaluator (PSE) 440, Resilient Layer Rectifier (RLR) 460, and Model Post-Processor 480. The PSE 440 and RLR 460 enable comparable model accuracy to unstructured pruning and are described in greater detail below. The PSE 440 and RLR 460 modules are crucial for readying a pruned model for edge training and deployment, especially considering that SPaI, on its own, does not maintain model accuracy with increased levels of pruning.

In FIG. 4, the end-user chooses as Input a dense DNN model 412, such as a VGG or ResNet, and a Pruning Degree 414, p∈[0, 1]. For example, p=0.8 equates to pruning 80% of the model parameters. The Input 410 is provided to the Model Pre-Processor 420 where the Input model 412 undergoes UP to the Pruning Degree 414 p in this module using a Model Initializer 422, a Dense Model Profiler 424, and an Unstructured Model Pruner 426. First, the Input model 412 is initialized in memory as a dense model via the Model Initializer 422 that loads the dense input weights into the chosen model architecture. Next, the Dense Model Profiler 424 is used to gather runtime metrics of the original Input model 412. Using a synthetic image input over a number of samples, the dense DNN model 412 is profiled for memory consumption, model size, and Central Processing Unit (CPU)/Graphics Processing Unit (GPU) latency. Finally, the Unstructured Model Pruner 426 looks at the size of the weights and ranks the weights by size, and applies UP to the dense DNN model 412. A percentage of the weights having low values are removed (e.g., weights below a predetermined value). Unstructured Model Pruner 426 applies UP by considering the Pruning Degree 414 (e.g., how much smaller to make the model—50% smaller, 90% smaller, and the like) For example, if the Pruning Degree 414 is set to 0.9 (90%), Unstructured Model Pruner 426 applies UP to remove 90% of the weights by setting lower valued weights to 0. However, as mentioned, processing speed for UP is not significantly faster. The output from Model Pre-Processor 420 is a sparse model pruned by the amount p 428.

The UPaI/SPaI Combination Pruning System 400 according to at least one embodiment is designed to be interoperable with existing model pruning systems. As such, the Unstructured Model Pruner 426 is fully configurable. Magnitude pruning is used by default as it is effective across a wide range of model architectures and datasets. However, this can be substituted for any other UP method, such as Synaptic Flow Pruning (SynFlow), Single-shot Network Pruning (SNIP), Gradient Signal Preservation (GraSP), and the like by user choice. SynFlow is an extension of magnitude pruning that preserves the total flow of synaptic strengths from input to output rather than the individual synaptic strengths themselves. SNIP discovers connections based on their influence on the loss function at a variance scaling initialization, which is referred to as connection sensitivity. Given the desired sparsity level, redundant connections are pruned once prior to training. GraSP prunes weights that most harm or least benefit the gradient flow.

As mentioned, SP is able to produce a faster model. However, instead of performing SP first and damaging the model, Pruning Sensitivity Evaluator (PSE) 440 identifies what parts of the neural network are important.

Pruning Sensitivity Evaluator (PSE) 440 evaluates the sensitivity of each layer to pruning by contrasting its sparsity with the average sparsity of the global model. First, a Sparsity Analyzer 442 looks at each layer to identify the sensitivity of the layer for pruning. The Sparsity Analyzer 442 calculates the per-layer sparsity of the sparse model created by Unstructured Model Pruner 426 of the Model Pre-Processor 420 by examining the sparsity pattern of the sparse model. The distribution of the sparsity is identified. Sparsity of the neural networks is distributed, for example, across 10 layers.

Next, the Prune Controller 444 determines where SP is to be applied by determining the sensitivity of each layer to pruning by comparing the sparsity of that specific layer with the average sparsity of the sparse model. The average sparsity is used to analyze the layers and prune some layers more than the average of the model. Layers with minimal unstructured pruning (low sparsity, under the average) are regarded as sensitive to pruning, while resilient layers contain a large number of redundant parameters and are unaffected by unstructured pruning. Using a pruning degree of 90% does not mean that each layer is pruned by 90%. Some layers are able to be pruned by 50%, for example, while 5% of other layers are able to be pruned by 99%.

A Prune Planner 446 sets up the data structure plan of how the layers are to be pruned. Resilient layers are pruned more and sensitive layers are pruned less. In the Prune Controller 444, sensitive layers are those which have a lower sparsity than the model average, whereas resilient layers are those which have a higher sparsity than the average. Determining layer sensitivity can be summarized with the following equation where pₗ is the pruning amount of the layer l and S_{Avg} is the average sparsity of the model:

$$P S E ( l ) \{ \begin{matrix}False & {p}_{l} \geq {S}_{Avg} \\ True & {p}_{l} < {S}_{Avg}\end{matrix} \qquad ( 1 )$$

Equation 1 provides a heuristic that uses the average sparsity as an indicator for determining whether to prune a layer, e.g., layer l.

Finally, the Prune Planner 446 calculates how much each resilient layer is to be pruned via structured pruning as the product of the number of channels in the layer by the sparsity of the layer and passes the Structured Prune Plan 448 to the Resilient Layer Rectifier (RLR) 460.

The Resilient Layer Rectifier (RLR) 460 uses a Layer Controller 462 to apply structure pruning to the resilient layers. Using the Structured Prune Plan 448 from PSE 440, Layer Controller 462 of RLR 460 applies SPaI to only the resilient layers. First, the number of channels is reduced proportionally to the layer density using the Structured Model Pruner 464. Next, the remaining channels are reinitialized as dense parameters using the Structured Reinitializer 466. A reinitialized structured pruned model 468 is thus generated.

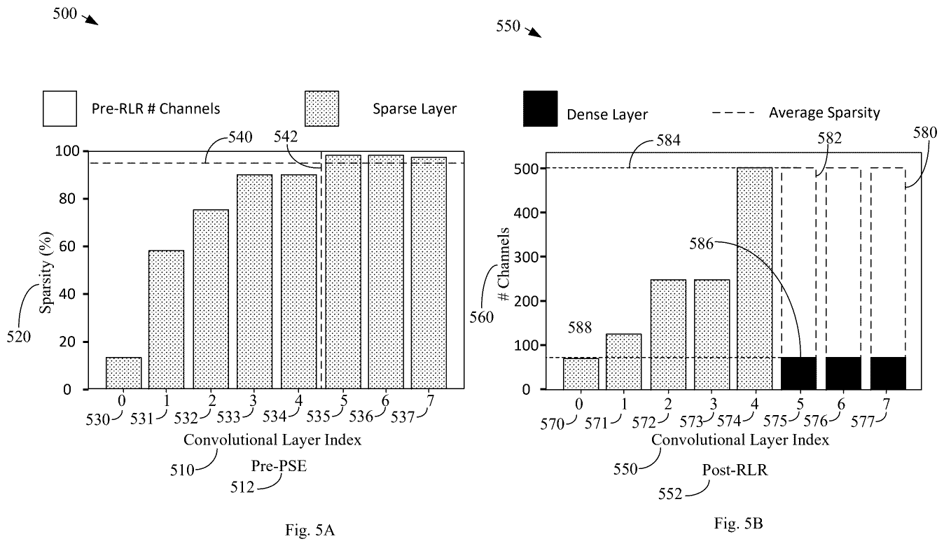

FIGS. 5A-B illustrate the convolution layer index Pre-PSE 500 and Post-RLR 540 according to at least one embodiment.

In FIG. 5A, the state of a Convolutional Layer Index 510 of each layer is shown after unstructured pruning but before PSE, i.e., Pre-PSE 512. The height of the bars represents the Sparsity (%) 520 of each layer, e.g., how sparse each layer is. The first layer 530 is only about 15% sparse, but the later layers 535, 536, 537 are 99% or 98% sparse. Each layer has a different Sparsity (%) 520, and the horizontal dashed line 540 is the overall average sparsity of the model. The vertical dashed line 542 represents a cutoff between layers that are sensitive and layers that are resilient. Layers 530, 531, 532, 533, 534 to the left of the vertical dashed line 542 are considered to be sensitive to pruning and, thereby, do not undergo structured pruning in the RLR. Layers 535, 536, 537 to the right of the vertical dashed line 542 are considered to be resilient to pruning.

Referring to FIG. 5B, the Convolutional Layer Index 550 of each layer the post-RLR state 552 is shown. The extent to which each resilient layer is pruned following SPaI is illustrated by the dashed outline 580, which indicates the number of Channels 560 present before the application of SPaI. The earlier layers 570, 571, 572, 573, 574 are untouched in terms of their weight. The later layers 575, 576, 577 have undergone SPaI to prune the number of channels. For instance, a sparse layer 582 with 500 channels 584, exhibiting a 85% sparsity following UP, is transformed into a Dense Layer model 586 that includes a predetermined number of channels, e.g., 75 channels 588.

Referring again to FIG. 4, the Model Post-Processor 480 reinitializes the remaining sensitive layers so that the model is reinitialized with pseudo-random Kaiming weights to complete pruning at initialization using the Unstructured Reinitializer 482. Kaiming weights considers the non-linearity of activation functions. Then, the remaining model contains a mix of reinitialized sparse and pruned layers and is ready for training and deployment. The Pruned Model Profiler 484 profiles the pruned model for the same metrics seen in the pre-processor to gather empirical speedup and compression metadata to produce an initialized model pruned by p 486. The metadata is used to determine what category of edge device the pruned model is trained and deployed to an edge device.

The Output 490 provides an initialized model pruned by p 486 to Model Training 492 and Model Deployment 494 using training hyperparameters (See, for example, Table II below) and deployed to an edge device.

### Implementation

The UPaI/SPaI Combination Pruning System 400 according to at least one embodiment is implemented using Python 3.11.4, Py-Torch 2.0.1, Torchvision 0.15.2, or CUDA 11.7 and is intended to be used as a straightforward and lightweight system for determining the amount to which each layer needs to be pruned during SPaI with the objective of edge-centric pruned models. PyTorch is a machine learning framework based on the Torch library, used for applications such as computer vision and natural language processing. Torchvision is a package that includes datasets, model architectures, and common image transformations for computer vision. CUDA (Compute Unified Device Architecture) is a parallel computing platform and application programming interface (API) that allows software to use certain types of graphics processing units (GPUs) for general-purpose processing. The PSE 440 and RLR 460 of the UPaI/SPaI Combination Pruning System 400 uses Algorithm 1-Pruning Sensitivity Evaluator (PSE) and Algorithm 2-Resilient Layer Rectifier (RLR), respectively. Algorithm 1 is used by PSE 440 to prepare a sparse model M for SPaI by calculating a layer-wise sparsity of each layer, and adjusting the number of channels in each SPaI layer. Algorithm 2 is used by RLR 460 to apply SPaI and reinitialization to the remaining parameters.

Algorithm 1 is the first step in preparing a sparse model M for SPaI. Algorithm 1 of PSE 440 includes two sub-steps.

Algorithm 1: Pruning Sensitivity Evaluator (PSE)

| Data: | Convolution layer/with a weight matrix W with shape | |
|---|---|---|
| | (N_{channels}, N_{weights}), Global average sparsity of the model S_{Avg}. | |
| Result: | Number of channels for layer l. | |
| 1 | Nₜₒₜₐₗ ← 0 | |
| 2 | N_{zero} ← 0 | |
| 3 | i ← 0 | |
| | // Calculate layer sparsity from sparse weights | |
| 4 | while i < N_{channels} do | |
| 5 | j ← 0 | |
| 6 | while j ← N_{weights} do | |
| 7 | Nₜₒₜₐₗ ← Nₜₒₜₐₗ + 1 | |
| 8 | if W_{i,j} == 0 then | |
| 9 | N_{zero} ← N_{zero} + 1 | |
| 10 | end | |
| 11 | j ← j + 1 | |
| 12 | end | |
| 13 | i ← i + 1 | |
| 14 | end | |
| 15 | ${p}_{i} ← \frac{{N}_{zero}}{{N}_{total}}$ | // Pruning degree of l |
| | | // Equation 1 |
| 16 | if pᵢ ≥ S_{Avg} then | |
| 17 | return ┌N_{channels} · pₗ┐ | // Resilient layer |
| 18 | end | |
| 19 | else | |
| 20 | return N_{channels} | // Sensitive layer |
| 21 | end | |

Step 1 involves calculating the layer-wise sparsity of each layer, and Step 2 involves adjusting the number of channels in each SPaI layer. Step 1 is achieved by iterating through the unstructured pruned layers and totaling the number of nonzero and zero parameters (sparse parameters)—Algorithm 1 Line 1-14. The sparsity of the layer, or pₗ, is the fraction of zero parameters divided by total parameters—Algorithm 1 Line 15. At this point, layer l only contains unstructured sparsity. Nonetheless, through SPaI, the objective is to create a structured pruned layer, denoted l′, while maintaining the same parameter count as l. This is achieved by reducing the number of channels, N_{channels} in l proportionally to pₗ. To accomplish this, PSE initially assesses whether 1 is to be pruned by computing its sensitivity according to Equation 1, as outlined in Line 16 of Algorithm 1. If l is resilient, then N_{channels} is scaled by pₗ and rounded up to the nearest full channel—Algorithm 1 Line 17. Otherwise, the layer is sensitive and remains untouched—Algorithm 1 Line 20.

Table II is a comparison of baseline model results and training hyperparameters for a production quality dense VGG-16, ResNet-20, and ResNet-50 models. VGG-16 is a convolutional neural network that is 16 layers deep. Residual Neural Network-20 (ResNet-20) is a 20 layer convolutional neural network. ResNet-50 is a convolutional neural network with 50 layers.

TABLE II

| | VGG-16 | ResNet-20 | ResNet-50 |
|---|---|---|---|
| Dataset | CIFAR-10 | CIFAR-10 | Tiny ImageNet |
| Parameters (M) | 14.72 | 0.27 | 25.56 |
| Size (MB) | 56.2 | 1.1 | 100.1 |
| Accuracy (%) | 93.32 | 91.68 | 55.48 |
| # Epochs | 160 | 160 | 200 |
| Batch Size | 128 | 128 | 256 |
| Learning Rate | 0.1 | 0.1 | 0.2 |
| Milestone Steps¹ | 80, 120 | 80, 120 | 100, 150 |

In Table II, at each milestone step, learning rate drops by a factor of gamma, 0.1.

Stochastic Gradient Descent (SGD) is used to calculate the data gradients. The above models use the SGD optimizer with momentum of 0.9 and weight decay of 0.0001.

Algorithm 2—Resilient Layer Rectifier (RLR) is the second step in the UPaI/SPaI Combination Pruning System 400 according to at least one embodiment, wherein SPaI and reinitialization of the remaining parameters are applied.

Algorithm 2 - Resilient Layer Rectifier (RLR)

| | |
|---|---|
| Data: | Original unstructured sparse model M, List of resilient layer indices R, List of |
| | pruned channel sizes for resilient layer indices C |

Result: Reinitialized pruned model M′

| 1 | M′ ← M | // Initialize M′ based on M |
|---|---|---|
| 2 | foreach layer l in M do | |
| 3 | if l is in R then | |
| 4 | M′l ← Structured Prune(l, Cₗ) | // Prune layer l to the size Cₗ |
| 5 | M′ₗ ← Reinitialize(M′ₗ) | // Reinitialize layer l |

| | |
|---|---|
| 6 | end |
| 7 | end |
| 8 | return M' |

A copy of which layers are resilient to pruning and the number of channels (N_{channels}) they are to be reduced to are provided as lists R and C, respectively. Next, sparse model M is iterated, and for each resilient layer, l in R undergoes structured pruning to the size Cₗ—Algorithm 2 Line 4. Finally, the pruned layer is fully reinitialized with random dense parameters—Algorithm 2 Line 5. Each step updates the pruned model reference M′ and is then returned—Algorithm 2 Line 8.

Achieving higher sparsity SPaI (>90%) with matching accuracy to UPaI allows for smaller pruned models to be discovered (within seconds). The UPaI/SPaI Combination Pruning System 400 according to at least one embodiment addresses the three challenges highlighted above simultaneously for pruning large DNN models to create compressed models suitable for resource-constrained devices in edge computing environments. The UPaI/SPaI Combination Pruning System 400 according to at least one embodiment achieves this by using unstructured and structured pruning methods at model initialization (Pal; i.e., before training). The UPaI/SPaI Combination Pruning System 400 according to at least one embodiment is the first system to maintain model accuracy up to extreme levels of model compression in this category. Other pruning systems apply pruning after model training, where a significant amount of computation is used to fine-tune the model after trained parameters are pruned away. The UPaI/SPaI Combination Pruning System 400 according to at least one embodiment preserves model accuracy by retaining important parameters by applying unstructured pruning at model initialization. In addition, less significant layers of a DNN, which contain parameters that least contribute to accuracy, undergo structured pruning. Thus, the UPaI/SPaI Combination Pruning System 400 according to at least one embodiment adopts a systematic approach to determine the significance of parameters and their contribution to the importance of DNN layers, which allows for a more precise structured pruning approach that reduces model size and accelerates training and inference while maintaining accuracy.

According to at least one embodiment, the UPaI/SPaI Combination Pruning System 400 is underpinned by a method of pruning at initialization (PaI) for Convolutional Neural Networks (CNN) to determine which layers are sensitive to structured pruning systematically. Experimental results for the UPaI/SPaI Combination Pruning System 400 according to at least one embodiment are discussed below that demonstrate that selective structured pruning based on layer sensitivity maintains accuracy on par with unstructured PaI methods, and that SPaI is able to be used to search for optimized pruned models rapidly. Then, train edge DNNs are able to be trained with lower resource overhead than existing methods such as Neural Architecture Search.

Thus, the UPaI/SPaI Combination Pruning System 400 according to at least one embodiment facilitates rapid pruning of DNN models for edge deployment and is underpinned by an SPaI method that closely matches UPaI accuracies, thereby enabling pruned models with high compression ratios and accelerated training/inference latencies for edge devices. The UPaI/SPaI Combination Pruning System 400 is able to be deploy a model across a range of heterogeneous edge devices where each instance of the model is selectively pruned on initialization for that device. The UPaI/SPaI Combination Pruning System 400 is suitable for use cases that use models that are to be tailored to resource availability or device capabilities for federated learning using small devices.

### Experiments

(1) Method Validation—Validating modules of UPaI/SPaI Combination Pruning System 400, namely Pruning Sensitivity Evaluator (PSE) 440 and Resilient Layer Rectifier (RLR) 460 across a range of sparsity, models, and datasets for evaluating model accuracy, compression, and CPU/GPU speedup.
(2) Training Benefits—Evaluating the accelerated training time and final accuracy of pruned models created with the UPaI/SPaI Combination Pruning System 400 according to at least one embodiment and comparing them against existing SPaI/UPaI methods and training a smaller model from scratch.
(3) Pruned Model Quality—Comparing the UPaI/SPaI Combination Pruning System 400 according to at least one embodiment to existing SPaI pruning systems and the runtime performance metrics of the pruned models across a range of sparsities.
(4) System Overheads—Contrasting the low overheads of the UPaI/SPaI Combination Pruning System 400 according to at least one embodiment against exhaustive NAS methods examining total time and memory usage for creating compressed models.

### Experimental Setup

Three DNN models trained on the CIFAR-10 and Tiny ImageNet datasets are considered. CIFAR-10 is a dataset that contains 60,000 32×32 color images in 10 different classes. The Tiny ImageNet dataset is a visual database used in visual object recognition software research. The first is VGG-16 trained on CIFAR-10, serving as a straightforward feedforward model. The other two, ResNet-20 and ResNet-50, are trained on CIFAR-10 and Tiny ImageNet, respectively, representing models with more intricate branching structures. Some experiments utilize VGG-19 (including the UPaI/SPaI Combination Pruning System 400 according to at least one embodiment) when other methods do not provide VGG-16 as a baseline in the literature. In addition, alternate versions of each baseline are used to compare pruned large models to smaller dense versions. For example, VGG-11 is a shallower version of VGG-16, and likewise, ResNet-8 is a shallower version of ResNet-20.

Models, Datasets, and Hyperparameters: The VGG models are those that include the OpenLTH configurations and have one fully connected layer, and ResNets are the default configurations for their respective datasets. CIFAR-10 includes 50,000 training images and 10,000 test images of the dimension 32×32×3 divided equally across 10 classes. Tiny ImageNet is a subset of ImageNet that includes 100,000 training images and 10,000 test images of the dimension 64×64×3 divided equally across 200 classes. The baseline results are obtained using the training routine of OpenLTH using the hyperparameters in Table II.

Testbed: An Advanced Micro Devices (AMD) EPYC 7713P 64-core/128-thread CPU and two Nvidia RTX A6000 GPUs are used to train, profile, and prune the Tiny ImageNet models, as such resources are representative of those in a cloud data center. CIFAR-10 experiments are carried out with an Intel i9-13900KS 24-core/32-thread CPU and an Nvidia RTX 3080 GPU comparable to an edge server that may be used in a production setting.

Trial Counts and Reporting Methods: Experiments were carried out three times. Unless otherwise specified, model performance indicators like accuracy, memory usage, and latency are presented in tables and figures as the mean from the experiments accompanied by confidence intervals spanning one standard deviation.

Pruning Setup: Pruning experiments are carried out across six different sparsities {50, 80, 90, 95, 97, 98} grouped into three difficulties from easy to hard. Trivial sparsities (Easy) {50, 80} are those in which even random pruning will match unstructured pruning. Matching sparsities (Medium) {90, 95} are those in which benchmark methods perform well and still match the unpruned dense model accuracy. Extreme sparsities (Hard) {97, 98} are those in which the accuracy of the models generated by unstructured pruning methods is lower than unpruned dense models.

Pruning Metrics: Accuracy is reported as absolute top-1 test accuracy when comparing pruned models from the same baseline model or relative top-1 test accuracy delta (Δ) when the baseline model accuracy cannot be replicated across different pruning systems. The mean model inference speedup of three trials is calculated as

$$\frac{Mean Dense Model Latency}{Mean Compressed Model Latency} .$$

Compression is calculated as

$$\frac{Dense Model Size}{Compressed Model Size}$$

where model size is the size of the model in storage. Note that this is different from using FLOPs and parameter count to calculate theoretical speedup and model size, respectively. Performance metrics that are empirically observed are used to highlight the practical benefits in real-world deployment scenarios.

Validation: The UPaI/SPaI Combination Pruning System 400 according to at least one embodiment is validated. The method underpinning the PSE module for determining layer sensitivity (Equation 1) is empirically validated against baseline methods considered below, as well as an inverted sensitivity method to demonstrate that the UPaI/SPaI Combination Pruning System 400 according to at least one embodiment maintains the same model accuracy as UPaI methods across a range of sparsities. Confounding variables are eliminated, such as differences in training hyperparameters or model architecture. Each method is tested on the same baseline model, testbed, and set of hyperparameters.

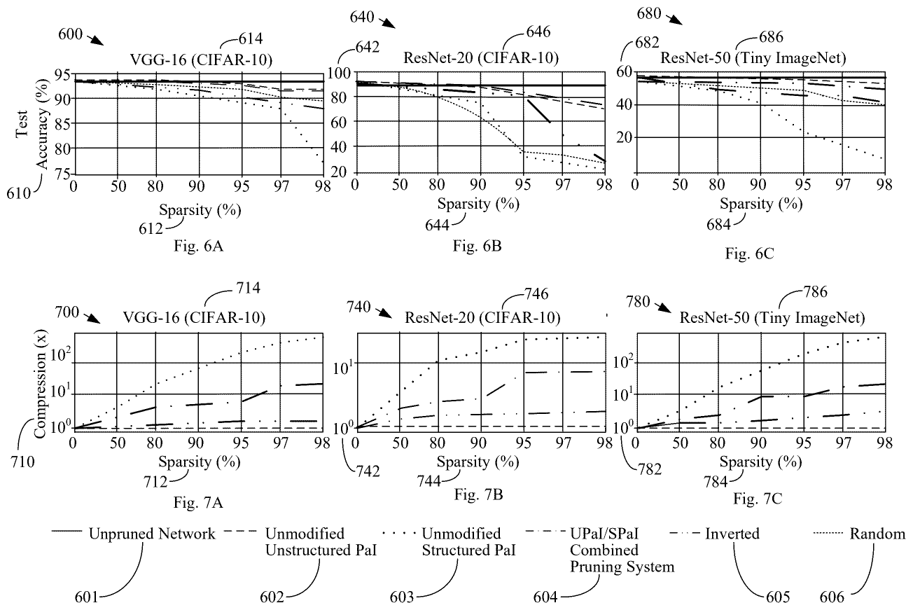

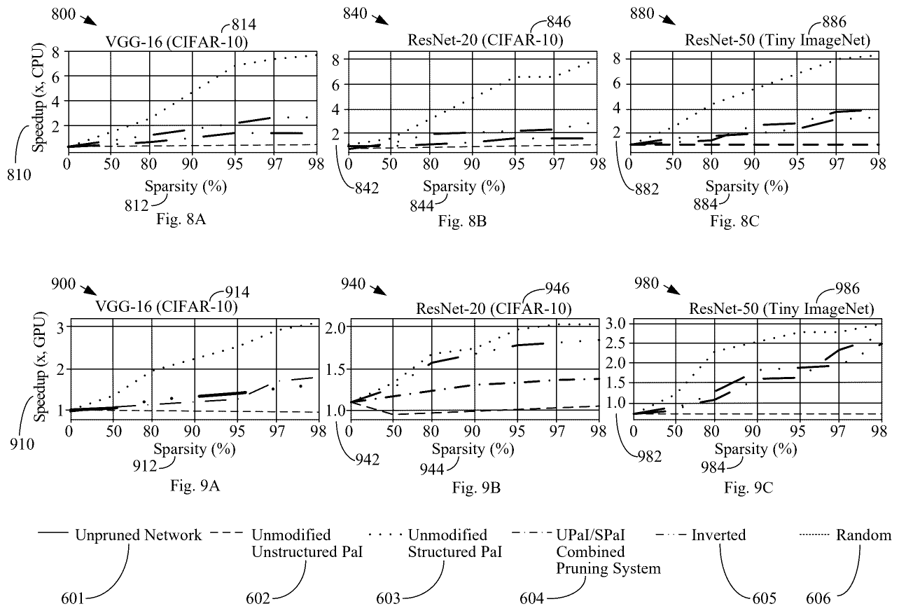

FIGS. 6A-C, 7A-C, 8A-C, and 9A-C are comparisons of test accuracy, compression, and CPU/GPU speedup across a range of sparsities for a selection of UPaI and SPaI pruning methods according to at least one embodiment.

For the plots in FIGS. 6A-C, 7A-C, 8A-C, and 9A-C, the methods considered are as follows:

Unpruned Network 601: Dense fully trained model representing maximum model accuracy, and is used as the reference for compression and speedup calculations.

Unmodified UPaI 602: Sparse model pruned with a magnitude-based unstructured pruning method as described below.

Unmodified SPaI 603: Pruned model following reparameterization of the Unmodified UPaI model as described in FIG. 2.

UPaI/SPaI Combination Pruning System 604: A two-step process of SPaI determines how sensitive each layer is to structured pruning, provides control for the amount and type of pruning of each layer in order to maximize model compression and speeds up the process while minimizing accuracy loss.

Inverted 605: the underlying method of the PSE Prune Controller component is inverted. In other words, structured pruning occurs on sensitive layers in the RLR.

Random 606: the PSE Prune Controller randomly assigns layers as sensitive.

In FIG. 6A 600, the Test Accuracy (%) 610 is plotted against Sparsity (%) 612 for a VGG-16 model on CIFAR-10 614. In FIG. 6B 640, the Test Accuracy (%) 642 is plotted against Sparsity (%) 644 for a ResNet-20 model on CIFAR-10 646. In FIG. 6C 680, the Test Accuracy (%) 682 is plotted against Sparsity (%) 684 for a ResNet-50 model on Tiny ImageNet datasets 686. Random 604 is plotted only for accuracy tests because of its large variance in compression and speedup during random pruning.

In FIG. 7A 700, the Compression (x) 710 is plotted against Sparsity (%) 712 for a VGG-16 model on CIFAR-10 714. In FIG. 7B 740, the Compression (x) 742 is plotted against Sparsity (%) 744 for a ResNet-20 model on CIFAR-10 746. In FIG. 7C 780, the Compression (x) 782 is plotted against Sparsity (%) 784 for a ResNet-50 model on Tiny ImageNet datasets 786.

In FIG. 8A 800, the Speedup (x, CPU) 810 is plotted against Sparsity (%) 812 for a VGG-16 model on CIFAR-10 814. In FIG. 8B 840, the Speedup (x, CPU) 842 is plotted against Sparsity (%) 844 for a ResNet-20 model on CIFAR-10 846. In FIG. 8C 880, the Speedup (x, CPU) 882 is plotted against Sparsity (%) 884 for a ResNet-50 model on Tiny ImageNet datasets 886.

In FIG. 9A 900, the Speedup (x, GPU) 910 is plotted against Sparsity (%) 912 for a VGG-16 model on CIFAR-10 914. In FIG. 9B 940, the Speedup (x, GPU) 942 is plotted against Sparsity (%) 944 for a ResNet-20 model on CIFAR-10 946. In FIG. 9C 980, the Speedup (x, GPU) 982 is plotted against Sparsity (%) 984 for a ResNet-50 model on Tiny ImageNet datasets 986.

FIGS. 6A-C, 7A-C, 8A-C, and 9A-C show the results for each method across multiple model architectures and datasets. For Test Accuracy for VGG-16 (CIFAR-10), for the levels of sparsity, the UPaI/SPaI Combination Pruning System 604 according to at least one embodiment is on par with UPaI 602 for accuracy. The SPaI 603, Inverted 605, and Random 606 methods, however, see a decline in accuracy beyond trivial sparsity levels of 80%. At 98% sparsity, the accuracy of the Random method 606 is 2% less than the UPaI/SPaI Combination Pruning System 604 according to at least one embodiment and UPaI 602, while SPaI 603 and Inverted 605 lag behind by 15% and 4%, respectively. This data supports the observation that the UPaI/SPaI Combination Pruning System 604 according to at least one embodiment is selectively pruning the right layers to maintain accuracy. In contrast, the Inverted method 605, which prunes the opposite set of layers, leads to reduced accuracy. Additionally, employing unmodified SPaI 603 to prune the layers results in the highest decline in model accuracy.

In terms of model Compression 610, 642, 682, UPaI 602 remains at 1× for the sparsity levels since zero parameters are the same size in storage as non-zero parameters. SPaI 603 obtains the highest compression, but SPaI 603 becomes impractical to use at extreme sparsity levels because of its diminished accuracy. The UPaI/SPaI Combination Pruning System 604 according to at least one embodiment achieves the second highest compression, primarily because resilient layers are typically found deeper in the DNN, and these layers are usually larger than the initial ones. On the other hand, the Inverted method 605 targets the more sensitive layers, which are smaller and positioned at the beginning of the DNN. Consequently, this results in a compression rate lower than the UPaI/SPaI Combination Pruning System 604.

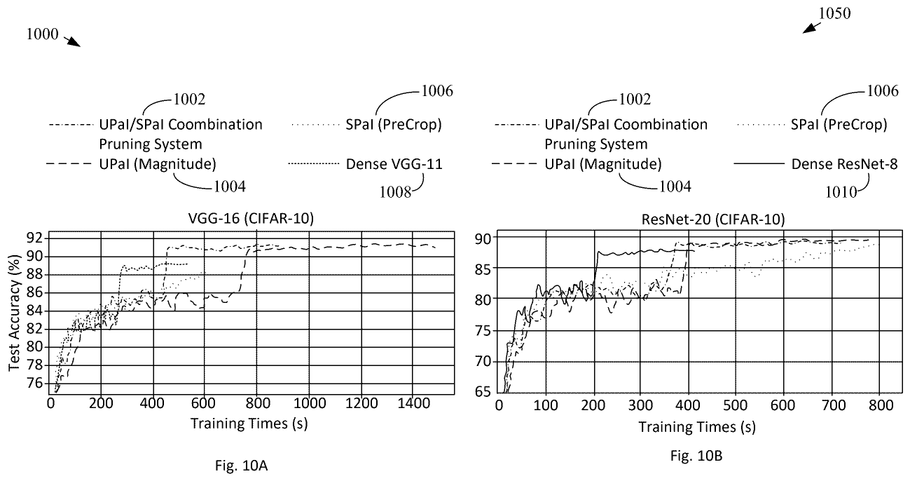

For CPU/GPU speedup 810/910, 842/942, 882/982, a similar trend is observed for SPaI 603, achieving the highest speedups but at the cost of model usability. Since the early layers, which the Inverted method 605 prunes, are typically slower than later layers, the Inverted method 605 obtains a higher speedup than the UPaI/SPaI Combination Pruning System 604. However, this is only observed in the CPU inference tests 800, 840, 880. The GPU inference test 900, 940, 980 shows that the UPaI/SPaI Combination Pruning System 604 and the Inverted method 603 obtain the same speedup at most sparsity levels. UPaI 602 demonstrates that without specialized hardware accelerators, sparse models cannot be effectively utilized. In fact, when accelerators are not available, a sparse model can sometimes be slower than its dense counterpart (up to 2% slower, as seen in FIGS. 10A-B).

For ResNet models on CIFAR-10 840, 940 and Tiny ImageNet 880, 980, the same trend is observed. The UPaI/SPaI Combination Pruning System 604 maintains the same accuracy as UPaI 802 for ResNet-20 with a small divergence at extreme sparsities for ResNet-50. In addition, the UPaI/SPaI Combination Pruning System 604 reaches 8× and 18.2× compression for ResNet-20 and ResNet-50 at 98% sparsity with about 2× CPU speedup on the models and 1.34× and 2.63× GPU speedup, respectively.

In summary, without sacrificing the model accuracy achieved by UPaI 602, the UPaI/SPaI Combination Pruning System 604 obtains up to 16.21× compression, 2× and 1.78× CPU and GPU speedup, respectively, by applying SPaI to resilient layers.

### Improvements During Training

During testing, the total training time and maximum accuracy achieved by the UPaI/SPaI Combination Pruning System 1002 is compared against another SPaI PreCrop 1006, UPaI 1004, and training a smaller model from the same architecture from scratch. This experiment aims to demonstrate that: (1) the UPaI/SPaI Combination Pruning System 1002 trains a model to full accuracy faster than UPaI 1004, (2) the UPaI/SPaI Combination Pruning System 1002 trains to a higher accuracy than other SPaI methods 1006, and (3) the UPaI/SPaI Combination Pruning System 1002 creates pruned models which train faster and to a higher accuracy than manually choosing a smaller model architecture and training it from scratch.

FIGS. 10A-B shows the accuracy for VGG-16 1000 and ResNet-20 1050 according to at least one embodiment.

For VGG-16 1000, UPaI 1004 takes 1,482 seconds to train to an accuracy of 91.24%. The UPaI/SPaI Combination Pruning System 1002 takes 884 seconds, 1.68× faster than UPaI 1004, to train to an accuracy of 91.26%. SPaI PreCrop 1006, which applies SPaI to the layers, trains to an accuracy of 88.26% in 607 seconds. Within the same timeframe, the UPaI/SPaI Combination Pruning System 1002 has already been trained to an accuracy of 90.6%. Furthermore, SPaI PreCrop 1006 trains more slowly and achieves a lower accuracy compared to VGG-11 1008 at 89.3% after 531 seconds. In this scenario, choosing VGG-11 1008 for deployment instead of pruning VGG-16 with SPaI PreCrop 1006 yields a higher-quality model in a shorter time. Conversely, the UPaI/SPaI Combination Pruning System 1002 achieved 91.1% accuracy in just 440 seconds of training, outperforming VGG-11 1008 and SPaI PreCrop 1004. Similarly, for ResNet-20 1050, UPaI 1004 takes 780 seconds to train to an accuracy of 89.37%. The UPaI/SPaI Combination Pruning System 1002 takes 725 seconds, 1.08× faster than UPaI 1004, to train to an accuracy of 89.2%. Notably, SPaI PreCrop 1006 takes longer than UPaI 1004 to train a ResNet-20 model at 807 seconds to a lower accuracy of 88.73%. Compared to a smaller model, ResNet-8 1010, the UPaI/SPaI Combination Pruning System 1002 reaches peak accuracy 1.09× faster. Whereas ResNet-8 1010 outperforms SPaI PreCrop 1006 in accuracy and training time.

In summary, the UPaI/SPaI Combination Pruning System 1002 achieves a higher accuracy faster than other SPaI/UPaI methods and smaller models. In fact, the UPaI/SPaI Combination Pruning System 1002 according to at least one embodiment trains a pruned VGG-16 to within 0.1% of UPaI 1002 3.37× faster.

### Comparison Against Other SPaI Methods

The UPaI/SPaI Combination Pruning System 1002, three alternative SPaI methods, and random pruning are evaluated based on accuracy change, GPU speedup, and compression to compare pruned model quality across a range of sparsity values. VGG-19 trained on CIFAR-10 is the baseline dense model. The three alternative SPaI methods are PreCrop, Prospect Pruning (ProsPr), and Single Shot Structured Pruning (3SP). PreCrop is a structured PaI that prunes CNN models at the channel level.

Table III presents the accuracy, speedup, and compression results for the methods. Since the source code for structured pruning used by 3SP and ProsPr are not publicly available, results for 3SP and ProsPr are not able to be replicated. Therefore, some results are missing. Nonetheless, these results are comparable to the UPaI/SPaI Combination Pruning System 400 as discussed above with reference to FIG. 4.

TABLE III

| Sparsity | Method | Acc. Δ | Speedup (x) | Comp. (x) |
|---|---|---|---|---|
| 80% | Random | −1.60 | — | — |
| | 3SP | −0.20 | — | — |
| | ProsPr | +0.01 | 1.10 | — |
| | PreCrop | −0.07 | 1.35 | 4.55 |
| | UPaI/SPaI Combination | −0.08 | 1.36 | 4.66 |
| | Pruning System | | | |
| 90% | Random | −3.20 | — | — |
| | 3SP | −0.50 | — | — |
| | ProsPr | 0.00 | 1.26 | — |
| | PreCrop | −0.26 | 1.63 | 8.89 |
| | UPaI/SPaI Combination | −0.12 | 1.43 | 5.33 |
| | Pruning System | | | |
| 95% | Random | −4.60 | — | — |
| | 3SP | −1.10 | — | — |
| | ProsPr | −0.28 | 1.30 | — |
| | PreCrop | −1.22 | 1.79 | 17.59 |
| | UPaI/SPaI Combination | −0.81 | 1.44 | 5.46 |
| | Pruning System | | | |

At 80% sparsity, the UPaI/SPaI Combination Pruning System creates the fastest and most compressed pruned model. However, ProsPr maintains 0.09% more accuracy. At 90% sparsity, PreCrop obtains a higher compression ratio and speedup, with a 0.14% lower accuracy than the UPaI/SPaI Combination Pruning System 400. The same trend is observed at 95% sparsity. However, the accuracy gap between PreCrop and the UPaI/SPaI Combination Pruning System 400 is now 0.41%. 3SP has the lowest accuracy outside of random pruning for the sparsities except for 95%, where PreCrop is lower. ProsPr achieves the smallest speedup because the fully connected layers of VGG-19 are pruned. Pruning these layers does not decrease inference latency as much as pruning the convolutional layers. At higher sparsity levels, PreCrop outperforms other methods in terms of speedup and compression because it prunes every layer in the DNN. However, this comes at the expense of reduced model accuracy than other methods.

In summary, the UPaI/SPaI Combination Pruning System 400 effectively balances the quality of pruned models, making the UPaI/SPaI Combination Pruning System 400 suitable for edge deployments. The UPaI/SPaI Combination Pruning System 400 maintains high accuracy while also speeding up and compressing the model significantly.

### Overheads

The UPaI/SPaI Combination Pruning System 400 according to at least one embodiment is assessed as a low-overhead one-shot neural architecture search (NAS) method for producing pruned models. The UPaI/SPaI Combination Pruning System 400 according to at least one embodiment is contrasted with other methods that discover their compressed models from an expansive search space. Moreover, The UPaI/SPaI Combination Pruning System 400 according to at least one embodiment is compared against traditional pruning after training (PaT).

Table IV presents the results for the UPaI/SPaI Combination Pruning System 400 according to at least one embodiment against six NAS methods and l¹ norm pruning after training (PaT).

TABLE IV

| | | Search | Memory | |
|---|---|---|---|---|
| Method | Type | Time (s) | Usage (GB) | Acc. Δ |
| ZenNAS | NAS | 19,944 | 4.8 | +2.70 |
| PNAS | NAS | 2,000 | 12.64 | −0.28 |
| DARTSv2 | NAS | 1,957 | 8.61 | −1.30 |
| NASNet | NAS | 1,468 | 11.73 | −1.32 |
| AmoebaNet | NAS | 2,113 | 12.55 | −0.95 |
| NASWOT | NAS | 306 | — | −0.88 |
| l¹ norm | PaT | 3 | 5.12 | −21.39 |
| UPaI/SPaI Combination | PaI | 1.37 | 0.32 | −0.81 |
| Pruning System | | | | |

In Table IV, search time, memory usage, and accuracy are presented for various search methods that are used to create a compressed model trained on CIFAR-10. Neural architecture search (NAS) methods are targeting 0.5 million parameters. Pruning after training (PaT) and pruning at initialization (PaI) methods are pruning VGG-16 to a sparsity of 95% (p=0.95, ˜0.5 million parameters). The top-1 accuracy change is based on a reference VGG-16 (CIFAR-10)

Search time is defined as the time to find the model candidate (does not include training time afterwards). The pruning methods achieve this in one shot by pruning the dense model into a smaller pruned model. NAS methods create many hundreds to thousands of candidate compressed models and then evaluate each for optimality. The UPaI/SPaI Combination Pruning System 400 according to at least one embodiment is 2.19× faster than l¹ norm since the UPaI/SPaI Combination Pruning System 400 prunes based on layer metrics whereas l¹ norm prunes based on the l¹ norm of each convolutional filter (larger calculation). In addition, the UPaI/SPaI Combination Pruning System 400 according to at least one embodiment produces a pruned model which trains to a higher accuracy than l¹ norm PaT.

Compared to the NAS methods, the UPaI/SPaI Combination Pruning System 400 according to at least one embodiment is 1,000× to 15,000× faster than NAS at discovering a pruned model and uses up to 40× less system memory. In addition, the model accuracy is higher than other NAS methods except for Progressive Neural Architecture Search (PNAS) and ZenNAS. PNAS is a method for learning the structure of convolutional neural networks (CNNs) that uses a sequential model-based optimization (SMBO) strategy. ZenNAS is a zero-shot neural architecture search framework for designing high performance deep image recognition networks, and has a post-search training regime 10× longer than typical, which results in a much higher final accuracy than the other methods.

In summary, the UPaI/SPaI Combination Pruning System 400 according to at least one embodiment serves as a search method to identify new pruned models suitable for edge devices, which traditionally relied on their larger cloud counterparts. The UPaI/SPaI Combination Pruning System 400 according to at least one embodiment operates significantly faster and yields models of similar accuracy. The UPaI/SPaI Combination Pruning System 400 according to at least one embodiment reduced memory usage further enable its execution on resource-constrained edge devices.

Pruning at initialization (PaI) allows for compressed models to be discovered rapidly. However, existing structured PaI methods sacrifice model accuracy to achieve the desired performance increase for resource-constrained edge computing. The UPaI/SPaI Combination Pruning System 400 according to at least one embodiment addresses this concern by closing the performance gap between unstructured and structured PaI while maintaining the accuracy of unstructured PaI through selective structured pruning of non-sensitive model layers. The UPaI/SPaI Combination Pruning System 400 according to at least one embodiment has been shown to work across a range of model architectures and datasets and serves as a foundation for future structured PaI methods.

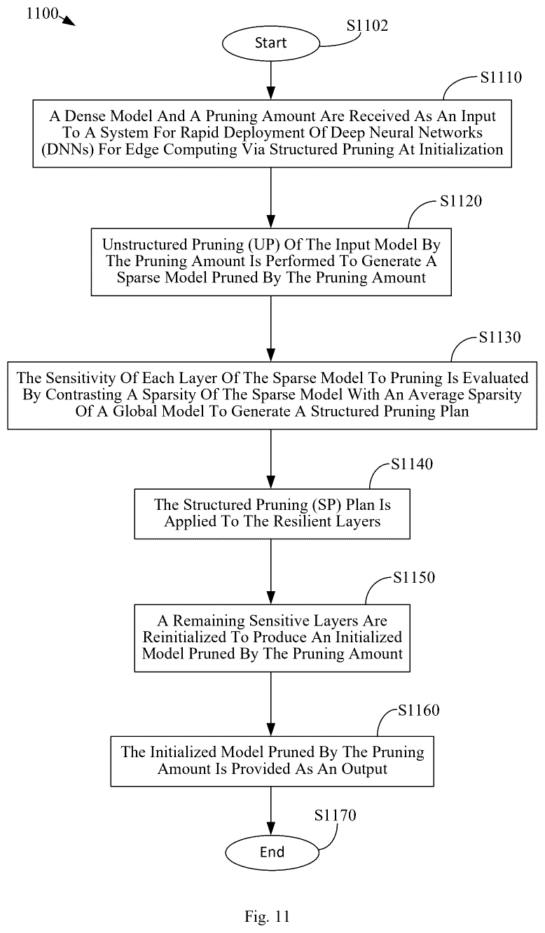

FIG. 11 is a flowchart 1100 of a method for providing rapid deployment of Deep Neural Networks (DNNs) for Edge Computing using Structured Pruning at Initialization (SPaI) according to at least one embodiment.

In FIG. 11, the process starts S1102, and a dense model and a pruning amount are received as an input to a system for rapid deployment of Deep Neural Networks (DNNs) for edge computing via structured pruning at initialization S1110. Referring to FIG. 4, the end-user chooses as Input a dense DNN model 412, such as a VGG or ResNet, and a Pruning Degree 414, p∈[0, 1]. For example, p=0.8 equates to pruning 80% of the model parameters.

Unstructured Pruning (UP) of the input model by the pruning amount is performed to generate a sparse model pruned by the pruning amount S1120. Referring to FIG. 4, the Input 410 is provided to the Model Pre-Processor 420 where the Input model 412 undergoes UP to the Pruning Degree 414 p in this module using a Model Initializer 422, a Dense Model Profiler 424, and an Unstructured Model Pruner 426. First, the Input model 412 is initialized in memory as a dense model via the Model Initializer 422 that loads the dense input weights into the chosen model architecture. Next, the Dense Model Profiler 424 is used to gather runtime metrics of the original Input model 412. Using a synthetic image input over a number of samples, the dense DNN model 412 is profiled for memory consumption, model size, and Central Processing Unit (CPU)/Graphics Processing Unit (GPU) latency. Finally, the Unstructured Model Pruner 426 looks at the size of the weights and ranks the weights by size, and applies UP to the dense DNN model 412. A percentage of the weights having low values are removed (e.g., weights below a predetermined value). Unstructured Model Pruner 426 applies UP by considering the Pruning Degree 414 (e.g., how much smaller to make the model—50% smaller, 90% smaller, and the like) For example, if the Pruning Degree 414 is set to 0.9 (90%), Unstructured Model Pruner 426 applies UP to remove 90% of the weights by setting lower valued weights to 0. However, as mentioned, processing speed for UP is not significantly faster. The output from Model Pre-Processor 420 is a sparse model pruned by the amount p 428.

The sensitivity of each layer of the sparse model to pruning is evaluated by contrasting a sparsity of the sparse model with an average sparsity of a global model to generate a structured pruning plan S1130. Referring to FIG. 4, Pruning Sensitivity Evaluator (PSE) 440 evaluates the sensitivity of each layer to pruning by contrasting its sparsity with the average sparsity of the global model. First, a Sparsity Analyzer 442 looks at each layer to identify the sensitivity of the layer for pruning. The Sparsity Analyzer 442 calculates the per-layer sparsity of the sparse model created by Unstructured Model Pruner 426 of the Model Pre-Processor 420 by examining the sparsity pattern of the sparse model. The distribution of the sparsity is identified. Sparsity of the neural networks is distributed, for example, across 10 layers. Next, the Prune Controller 444 determines where SP is to be applied by determining the sensitivity of each layer to pruning by comparing the sparsity of that specific layer with the average sparsity of the sparse model. The average sparsity is used to analyze the layers and prune some layers more than the average of the model. Layers with minimal unstructured pruning (low sparsity, under the average) are regarded as sensitive to pruning, while resilient layers contain a large number of redundant parameters and are unaffected by unstructured pruning. Using a pruning degree of 90% does not mean that each layer is pruned by 90%. Some layers are able to be pruned by 50%, for example, while 5% of other layers are able to be pruned by 99%. A Prune Planner 446 sets up the data structure plan of how the layers are to be pruned. Resilient layers are pruned more and sensitive layers are pruned less. In the Prune Controller 444, sensitive layers are those which have a lower sparsity than the model average, whereas resilient layers are those which have a higher sparsity than the average. Finally, the Prune Planner 446 calculates how much each resilient layer is to be pruned via structured pruning as the product of the number of channels in the layer by the sparsity of the layer and passes the Structured Prune Plan 448 to the Resilient Layer Rectifier (RLR) 460.

The structured pruning (SP) plan is applied to the resilient layers S1140. Referring to FIG. 4, the Resilient Layer Rectifier (RLR) 460 uses a Layer Controller 462 to apply structure pruning to the resilient layers. Using the Structured Prune Plan 448 from PSE 440. Layer Controller 462 of RLR 460 applies SPaI to only the resilient layers. First, the number of channels is reduced proportionally to the layer density using the Structured Model Pruner 464.

A remaining sensitive layers are reinitialized to produce an initialized model pruned by the pruning amount S1150. Referring to FIG. 4, the remaining channels are reinitialized as dense parameters using the Structured Reinitializer 466.

The initialized model pruned by the pruning amount is provided as an output S1160. Referring to FIG. 4, the Model Post-Processor 480 reinitializes the remaining sensitive layers so that the model is reinitialized with pseudo-random Kaiming weights to complete pruning at initialization using the Unstructured Reinitializer 482. Kaiming weights considers the non-linearity of activation functions. Then, the remaining model contains a mix of reinitialized sparse and pruned layers and is ready for training and deployment. The Pruned Model Profiler 484 profiles the pruned model for the same metrics seen in the pre-processor to gather empirical speedup and compression metadata to produce an initialized model pruned by p 486. The metadata is used to determine what category of edge device the pruned model is trained and deployed to an edge device. The Output 490 provides an initialized model pruned by p 486 to Model Training 492 and Model Deployment 494 using training hyperparameters (See, for example, Table II below) and deployed to an edge device.

The process then terminates S1170.

At least one embodiment, the method for providing rapid deployment of Deep Neural Networks (DNNs) for Edge Computing using Structured Pruning at Initialization (SPaI) includes receiving as an input a dense model and a pruning amount. Unstructured Pruning (UP) of the input model is performed by the pruning amount to generate a sparse model pruned by the pruning amount. The sensitivity of each layer of the sparse model to pruning is evaluated by contrasting a sparsity of the sparse model with an average sparsity of a global model to generate a structured pruning plan. The structured pruning plan is applied to the resilient layers. A remaining sensitive layers are reinitialized to produce an initialized model pruned by the pruning amount. The initialized model pruned by the pruning amount is provided as an output.

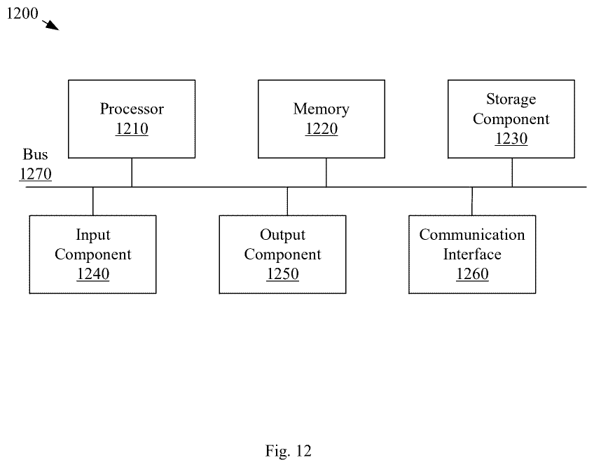

FIG. 12 illustrates an exemplary embodiment of a device 1200 according to at least one embodiment. As shown in FIG. 12, the device 1200 may include a processor 1210, a memory 1220, a storage component 1230, an input component 1240, an output component 1250, a communication interface 1260, and a bus 1270.

The processor 1210, as used herein, means any type of computational circuit that may comprise hardware elements and software elements. The processor 1210 may be embodied as a multi-core processor, a single core processor, or a combination of one or more multi-core processors and one or more single core processors, a distributed processing system, or the like. The processor 1210 may be a Central Processing Unit (CPU) a graphics processing unit (GPU), an accelerated processing unit (APU), an application-specific integrated circuit (ASIC), or another type of processing component.

Memory 1220 includes a random-access memory (RAM), a read only memory (ROM), and/or another type of dynamic or static storage device (e.g., a flash memory, a magnetic memory, and/or an optical memory) that stores information and/or instructions for use by processor 1210. The memory 1220 comprises machine-readable instructions which are executable by the processor 1210. These machine-readable instructions when executed by the processor 1210 cause the processor 1210 to perform method steps of an exemplary embodiment described herein.

Storage component 1230 stores information and/or software related to the operation and use of the device 1200. For example, storage component 1230 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 1240 is configured to receive information, such as via user input. For example, the input component 1240 may include, but not be limited to, a touch screen display, a keyboard, a keypad, a mouse, a button, a switch, and/or a microphone. Additionally, or alternatively, the input component 1240 may include a sensor for sensing information (e.g., a global positioning system (GPS), an accelerometer, a gyroscope, and/or an actuator).

Output component 1250 is configured to provide output information from the device 1200. For example, the output component 1250 may be, but not limited to, a display, a speaker, and/or one or more light-emitting diodes (LEDs).

Communication interface 1260 is an interface that provides a communication connection to other devices. The connection by the communication interface 1260 can be a wired connection, a wireless connection, or a combination of wired and wireless connections, and can be a direct connection or an indirect connection via a communication network that exists between other devices. In other words, the standard of the communication interface 1260 is not limited.

The bus 1270 acts as an interconnect between the processor 1210, the memory 1220, the storage component 1230, the input component 1240, the output component 1250, and the communication interface 1260 of the device 1200.

The number and arrangement of components shown in FIG. 12 are provided as an example. In practice, device 1200 may include additional components, fewer components, different components, or differently arranged components than those shown in FIG. 12. Additionally, or alternatively, a set of components (e.g., one or more components) of device 1200 may perform one or more functions described as being performed by another set of components of device 1200.

Embodiments described herein provide a method that provides one or more advantages. For example, pruned models suited for edge deployments are rapidly generated using structured Pruning at Initialization (PaI) by systematically identifying convolutional layers of a Deep Neural Network (DNN) that are most sensitive to Structured Pruning and prunes only the non-sensitive layers. At least one embodiment rapidly prunes DNNs within seconds and are much smaller and faster (e.g., up to 16.21× smaller and 2×faster) while the same accuracy as an unstructured PaI counterpart is maintained.

An aspect of this description is directed to a method [1] for providing rapid deployment of Deep Neural Networks (DNNs) for Edge Computing using Structured Pruning at Initialization (SPaI) includes receiving as an input a dense model and a pruning amount, performing Unstructured Pruning of the input model by the pruning amount to generate a sparse model pruned by the pruning amount, evaluating the sensitivity of each layer of the sparse model to pruning by contrasting a sparsity of the sparse model with an average sparsity of a global model to generate a structured pruning plan, applying the structured pruning plan to the resilient layers, reinitializing a remaining sensitive layers to produce an initialized model pruned by the pruning amount, and providing as an output the initialized model pruned by the pruning amount.

The method described in [1], wherein the performing the Unstructured Pruning of the input model by the pruning amount further includes initializing the dense model in memory by loading the dense input weights into the dense model, obtaining runtime metrics of the of the dense model using a synthetic image input over a number of samples, to profile the dense model for memory consumption, model size, and Central Processing Unit (CPU)/Graphics Processing Unit (GPU) latency, and performing magnitude pruning to apply unstructured pruning to the dense model to generate the sparse model pruned to the pruning amount.

The method described in any one of [1] or [2], wherein the evaluating the sensitivity of each layer to pruning by contrasting a sparsity of the sparse model with an average sparsity of a global model includes calculating a per-layer sparsity of the sparse model by examining the sparsity pattern of the sparse model and generating a structured pruning plan, determining the sensitivity of each layer of the sparse model to pruning by comparing the sparsity of specific layers with the average sparsity of the sparse model, identifying layers with minimal unstructured pruning having a sparsity under the average as sensitive to pruning, and identifying layers as resilient layers that have a sparsity above the average, the resilient layers containing a large number of redundant parameters and are unaffected by unstructured pruning, calculating an amount each resilient layer is to be pruned via structured pruning as the product of the number of channels in the layer and the sparsity of the layer, and generating the structured prune plan based on the amount each resilient layer is to be pruned via structured pruning.

The method described in any one of [1] to [3], wherein the applying the structure pruning plan to the resilient layers further includes applying Structured Pruning at Initialization (SPaI) to the resilient layers according to the structured pruning plan, reducing a number of channels proportionally to the layer density, and reinitializing the remaining channels as dense parameters.

The method described in any one of [1] to [4], wherein the reinitializing the remaining sensitive layers to produce an initialized model pruned by the pruning amount further includes reinitializing the sparse model with pseudo-random Kaiming weights to complete pruning at initialization, generating the initialized model containing a mix of reinitialized sparse and pruned layers for training and deployment, and profiling the initialized model for the metrics seen in the pre-processor to gather empirical speedup and compression metadata.

The method described in [5], wherein the metadata is used to determine what category of edge device the initialized model is to be trained and deployed.

The method described in any one of [1] to [5], wherein the providing as the output the initialized model pruned by the pruning amount further includes training the initialized model pruned by the pruning amount using training hyperparameters to obtain a trained initialized model, and deploying the trained initialized model to an edge device.

An aspect of this description is directed to a system for rapid deployment of Deep Neural Networks (DNNs) for edge computing via structured pruning at initialization [8], wherein the system is configured for receiving as an input a dense model and a pruning amount, performing Unstructured Pruning of the input model by the pruning amount to generate a sparse model pruned by the pruning amount, evaluating the sensitivity of each layer of the sparse model to pruning by contrasting a sparsity of the sparse model with an average sparsity of a global model to generate a structured pruning plan, applying the structured pruning plan to the resilient layers, reinitializing a remaining sensitive layers to produce an initialized model pruned by the pruning amount, and providing as an output the initialized model pruned by the pruning amount.

The system described in [8], wherein the performing the Unstructured Pruning of the input model by the pruning amount further includes initializing the dense model in memory by loading the dense input weights into the dense model, obtaining runtime metrics of the of the dense model using a synthetic image input over a number of samples, to profile the dense model for memory consumption, model size, and Central Processing Unit (CPU)/Graphics Processing Unit (GPU) latency, and performing magnitude pruning to apply unstructured pruning to the dense model to generate the sparse model pruned to the pruning amount.

The system described in any one of [8] or [9], wherein the evaluating the sensitivity of each layer to pruning by contrasting a sparsity of the sparse model with an average sparsity of a global model includes calculating a per-layer sparsity of the sparse model by examining the sparsity pattern of the sparse model and generating a structured pruning plan, determining the sensitivity of each layer of the sparse model to pruning by comparing the sparsity of specific layers with the average sparsity of the sparse model, identifying layers with minimal unstructured pruning having a sparsity under the average as sensitive to pruning, and identifying layers as resilient layers that have a sparsity above the average, the resilient layers containing a large number of redundant parameters and are unaffected by unstructured pruning, calculating an amount each resilient layer is to be pruned via structured pruning as the product of the number of channels in the layer and the sparsity of the layer, and generating the structured prune plan based on the amount each resilient layer is to be pruned via structured pruning.

The system described in any one of [8] to [10], wherein the applying the structure pruning plan to the resilient layers further includes applying Structured Pruning at Initialization (SPaI) to the resilient layers according to the structured pruning plan, reducing a number of channels proportionally to the layer density, and reinitializing the remaining channels as dense parameters.

The system described in any one of [8] to [11], wherein the reinitializing the remaining sensitive layers to produce an initialized model pruned by the pruning amount further includes reinitializing the sparse model with pseudo-random Kaiming weights to complete pruning at initialization, generating the initialized model containing a mix of reinitialized sparse and pruned layers for training and deployment, and profiling the initialized model for the metrics seen in the pre-processor to gather empirical speedup and compression metadata.

The system described in [12], wherein the metadata is used to determine what category of edge device the initialized model is to be trained and deployed.

The system described in any one of [8] to [12], wherein the providing as the output the initialized model pruned by the pruning amount further includes training the initialized model pruned by the pruning amount using training hyperparameters to obtain a trained initialized model, and deploying the trained initialized model to an edge device.

An aspect of this description is directed to a non-transitory computer-readable media having computer-readable instructions stored thereon [15], which when executed by a processor causes the processor to perform operations including receiving as an input a dense model and a pruning amount, performing Unstructured Pruning of the input model by the pruning amount to generate a sparse model pruned by the pruning amount, evaluating the sensitivity of each layer of the sparse model to pruning by contrasting a sparsity of the sparse model with an average sparsity of a global model to generate a structured pruning plan, applying the structured pruning plan to the resilient layers, reinitializing a remaining sensitive layers to produce an initialized model pruned by the pruning amount, and providing as an output the initialized model pruned by the pruning amount.

The non-transitory computer-readable media described in [15], wherein the performing the Unstructured Pruning of the input model by the pruning amount further includes initializing the dense model in memory by loading the dense input weights into the dense model, obtaining runtime metrics of the of the dense model using a synthetic image input over a number of samples, to profile the dense model for memory consumption, model size, and Central Processing Unit (CPU)/Graphics Processing Unit (GPU) latency, and performing magnitude pruning to apply unstructured pruning to the dense model to generate the sparse model pruned to the pruning amount.

The non-transitory computer-readable media described in any one of [15] or [16], wherein the evaluating the sensitivity of each layer to pruning by contrasting a sparsity of the sparse model with an average sparsity of a global model includes calculating a per-layer sparsity of the sparse model by examining the sparsity pattern of the sparse model and generating a structured pruning plan, determining the sensitivity of each layer of the sparse model to pruning by comparing the sparsity of specific layers with the average sparsity of the sparse model, identifying layers with minimal unstructured pruning having a sparsity under the average as sensitive to pruning, and identifying layers as resilient layers that have a sparsity above the average, the resilient layers containing a large number of redundant parameters and are unaffected by unstructured pruning, calculating an amount each resilient layer is to be pruned via structured pruning as the product of the number of channels in the layer and the sparsity of the layer, and generating the structured prune plan based on the amount each resilient layer is to be pruned via structured pruning.

The non-transitory computer-readable media described in any one of [15] or [17], wherein the applying the structure pruning plan to the resilient layers further includes applying Structured Pruning at Initialization (SPaI) to the resilient layers according to the structured pruning plan, reducing a number of channels proportionally to the layer density, and reinitializing the remaining channels as dense parameters.

The non-transitory computer-readable media described in any one of [15] or [18], wherein the reinitializing the remaining sensitive layers to produce an initialized model pruned by the pruning amount further includes reinitializing the sparse model with pseudo-random Kaiming weights to complete pruning at initialization, generating the initialized model containing a mix of reinitialized sparse and pruned layers for training and deployment, and profiling the initialized model for the metrics seen in the pre-processor to gather empirical speedup and compression metadata, wherein the metadata is used to determine what category of edge device the initialized model is to be trained and deployed.

The non-transitory computer-readable media described in any one of [15] or [19], wherein the providing as the output the initialized model pruned by the pruning amount further includes training the initialized model pruned by the pruning amount using training hyperparameters to obtain a trained initialized model, and deploying the trained initialized model to an edge device. Separate instances of these programs can be executed on or distributed across any number of separate computer systems. Thus, although certain steps have been described as being performed by certain devices, software programs, processes, or entities, this need not be the case. A variety of alternative implementations will be understood by those having ordinary skill in the art.

Additionally, those having ordinary skill in the art readily recognize that the techniques described above can be utilized in a variety of devices, environments, and situations. Although the embodiments have been described in language specific to structural features or methodological acts, the subject matter defined in the appended claims is not necessarily limited to the specific features or acts described. Rather, the specific features and acts are disclosed as exemplary forms of implementing the claims.

What is claimed is:

1. A method for providing rapid deployment of Deep Neural Networks (DNNs) for Edge Computing using Structured Pruning at Initialization (SPaI), comprising;
receiving as an input a dense model and a pruning amount;
performing Unstructured Pruning of the dense model by the pruning amount to generate a sparse model pruned by the pruning amount;
evaluating a sensitivity of each layer of the sparse model to pruning by contrasting a sparsity of the sparse model with an average sparsity of a global model to generate a structured pruning plan;
applying the structured pruning plan to resilient layers of the sparse model;
reinitializing a remaining sensitive layers to produce an initialized model pruned by the pruning amount; and
providing as an output the initialized model pruned by the pruning amount.

2. The method of claim 1, wherein the performing the Unstructured Pruning of the dense model by the pruning amount further includes:
initializing the dense model in memory by loading the dense input weights into the dense model;
obtaining runtime metrics of the of the dense model using a synthetic image input over a number of samples, to profile the dense model for memory consumption, model size, and Central Processing Unit (CPU)/Graphics Processing Unit (GPU) latency; and
performing magnitude pruning to apply unstructured pruning to the dense model to generate the sparse model pruned to the pruning amount.

3. The method of claim 1, wherein the evaluating the sensitivity of each layer to pruning by contrasting the sparsity of the sparse model with the average sparsity of the global model includes:
calculating a per-layer sparsity of the sparse model by examining a sparsity pattern of the sparse model and generating the structured pruning plan;
determining the sensitivity of each layer of the sparse model to pruning by comparing a sparsity of specific layers with an average sparsity of the sparse model;
identifying layers with minimal unstructured pruning having a sparsity under the average as sensitive to pruning, and identifying layers as resilient layers that have a sparsity above the average, the resilient layers containing a large number of redundant parameters and are unaffected by unstructured pruning;
calculating an amount each resilient layer is to be pruned via structured pruning as a product of a number of channels in the resilient layer and the sparsity of the resilient layer; and
generating the structured pruning plan based on the amount each resilient layer is to be pruned via structured pruning.

4. The method of claim 1, wherein the applying the structure pruning plan to the resilient layers further includes:
applying Structured Pruning at Initialization (SPaI) to the resilient layers according to the structured pruning plan;
reducing a number of channels proportionally to a layer density; and
reinitializing remaining channels as dense parameters.

5. The method of claim 1, wherein the reinitializing the remaining sensitive layers to produce the initialized model pruned by the pruning amount further includes:
reinitializing the sparse model with pseudo-random Kaiming weights to complete pruning at initialization;
generating the initialized model containing a mix of reinitialized sparse and pruned layers for training and deployment; and
profiling the initialized model for metrics seen in a pre-processor to gather empirical speedup and compression metadata.

6. The method of claim 5, wherein the metadata is used to determine what category of edge device the initialized model is to be trained and deployed.

7. The method of claim 1, wherein the providing as the output the initialized model pruned by the pruning amount further includes:
training the initialized model pruned by the pruning amount using training hyperparameters to obtain a trained initialized model; and
deploying the trained initialized model to an edge device.

8. A system for rapid deployment of Deep Neural Networks (DNNs) for edge computing via structured pruning at initialization, wherein the system is configured for:
receiving as an input a dense model and a pruning amount;
performing Unstructured Pruning of the dense model by the pruning amount to generate a sparse model pruned by the pruning amount;
evaluating a sensitivity of each layer of the sparse model to pruning by contrasting a sparsity of the sparse model with an average sparsity of a global model to generate a structured pruning plan;
applying the structured pruning plan to resilient layers of the sparse model;
reinitializing a remaining sensitive layers to produce an initialized model pruned by the pruning amount; and
providing as an output the initialized model pruned by the pruning amount.

9. The system of claim 8, wherein the performing the Unstructured Pruning of the dense model by the pruning amount further includes:
initializing the dense model in memory by loading the dense input weights into the dense model;
obtaining runtime metrics of the of the dense model using a synthetic image input over a number of samples, to profile the dense model for memory consumption, model size, and Central Processing Unit (CPU)/Graphics Processing Unit (GPU) latency; and
performing magnitude pruning to apply unstructured pruning to the dense model to generate the sparse model pruned to the pruning amount.

10. The system of claim 8, wherein the evaluating the sensitivity of each layer to pruning by contrasting the sparsity of the sparse model with the average sparsity of the global model includes:
calculating a per-layer sparsity of the sparse model by examining a sparsity pattern of the sparse model and generating the structured pruning plan;
determining the sensitivity of each layer of the sparse model to pruning by comparing a sparsity of specific layers with an average sparsity of the sparse model;
identifying layers with minimal unstructured pruning having a sparsity under the average as sensitive to pruning, and identifying layers as resilient layers that have a sparsity above the average, the resilient layers containing a large number of redundant parameters and are unaffected by unstructured pruning;
calculating an amount each resilient layer is to be pruned via structured pruning as a product of a number of channels in the resilient layer and the sparsity of the resilient layer; and
generating the structured pruning plan based on the amount each resilient layer is to be pruned via structured pruning.

11. The system of claim 8, wherein the applying the structure pruning plan to the resilient layers further includes:
applying Structured Pruning at Initialization (SPaI) to the resilient layers according to the structured pruning plan;
reducing a number of channels proportionally to a layer density; and
reinitializing remaining channels as dense parameters.

12. The system of claim 8, wherein the reinitializing the remaining sensitive layers to produce the initialized model pruned by the pruning amount further includes:
reinitializing the sparse model with pseudo-random Kaiming weights to complete pruning at initialization;
generating the initialized model containing a mix of reinitialized sparse and pruned layers for training and deployment; and
profiling the initialized model for metrics seen in a pre-processor to gather empirical speedup and compression metadata.

13. The system of claim 12, wherein the metadata is used to determine what category of edge device the initialized model is to be trained and deployed.

14. The system of claim 8, wherein the providing as the output the initialized model pruned by the pruning amount further includes:
training the initialized model pruned by the pruning amount using training hyperparameters to obtain a trained initialized model; and
deploying the trained initialized model to an edge device.

15. A non-transitory computer-readable media having computer-readable instructions stored thereon, which when executed by a processor causes the processor to perform operations comprising:
receiving as an input a dense model and a pruning amount;
performing Unstructured Pruning of the dense model by the pruning amount to generate a sparse model pruned by the pruning amount;
evaluating a sensitivity of each layer of the sparse model to pruning by contrasting a sparsity of the sparse model with an average sparsity of a global model to generate a structured pruning plan;
applying the structured pruning plan to resilient layers of the sparse model;
reinitializing a remaining sensitive layers to produce an initialized model pruned by the pruning amount; and
providing as an output the initialized model pruned by the pruning amount.

16. The non-transitory computer-readable media of claim 15, wherein the performing the Unstructured Pruning of the dense model by the pruning amount further includes:
initializing the dense model in memory by loading the dense input weights into the dense model;
obtaining runtime metrics of the of the dense model using a synthetic image input over a number of samples, to profile the dense model for memory consumption, model size, and Central Processing Unit (CPU)/Graphics Processing Unit (GPU) latency; and
performing magnitude pruning to apply unstructured pruning to the dense model to generate the sparse model pruned to the pruning amount.

17. The non-transitory computer-readable media of claim 15, wherein the evaluating the sensitivity of each layer to pruning by contrasting the sparsity of the sparse model with the average sparsity of the global model includes:
calculating a per-layer sparsity of the sparse model by examining a sparsity pattern of the sparse model and generating the structured pruning plan;
determining the sensitivity of each layer of the sparse model to pruning by comparing a sparsity of specific layers with an average sparsity of the sparse model;
identifying layers with minimal unstructured pruning having a sparsity under the average as sensitive to pruning, and identifying layers as resilient layers that have a sparsity above the average, the resilient layers containing a large number of redundant parameters and are unaffected by unstructured pruning;
calculating an amount each resilient layer is to be pruned via structured pruning as a product of a number of channels in the resilient layer and the sparsity of the resilient layer; and
generating the structured pruning plan based on the amount each resilient layer is to be pruned via structured pruning.

18. The non-transitory computer-readable media of claim 15, wherein the applying the structure pruning plan to the resilient layers further includes:
applying Structured Pruning at Initialization (SPaI) to the resilient layers according to the structured pruning plan;
reducing a number of channels proportionally to a layer density; and
reinitializing remaining channels as dense parameters.

19. The non-transitory computer-readable media of claim 15, wherein the reinitializing the remaining sensitive layers to produce the initialized model pruned by the pruning amount further includes:
reinitializing the sparse model with pseudo-random Kaiming weights to complete pruning at initialization;
generating the initialized model containing a mix of reinitialized sparse and pruned layers for training and deployment; and
profiling the initialized model for metrics seen in a pre-processor to gather empirical speedup and compression metadata;
wherein the metadata is used to determine what category of edge device the initialized model is to be trained and deployed.

20. The non-transitory computer-readable media of claim 15, wherein the providing as the output the initialized model pruned by the pruning amount further includes:
training the initialized model pruned by the pruning amount using training hyperparameters to obtain a trained initialized model; and
deploying the trained initialized model to an edge device.
